(19) United States
(12) Patent Application Publication
(10) Pub. No.: US 2025/0031180 A1
(43) Pub. Date: Jan. 23, 2025

(54) SYSTEMS AND METHODS OF UTILIZING ADAPTER FACILITATED CONVERSIONS FOR SECURE COMMUNICATIONS BETWEEN DEVICES

(71) Applicant: Physio-Control, Inc., Redmond, WA (US)

(72) Inventors: Robert Greenewald, Snohomish, WA (US); Brendan Greetham, Seattle, WA (US)

(73) Assignee: Physio-Control, Inc., Redmond, WA (US)

(21) Appl. No.: 18/777,248

(22) Filed: Jul. 18, 2024

Related U.S. Application Data
(60) Provisional application No. 63/514,193, filed on Jul. 18, 2023.

(51) Int. Cl. H04W 64/00; H04W 12/06; H04W 80/02

(52) U.S. Cl. CPC H04W 64/006; H04W 12/06; H04W 80/02

(57) ABSTRACT

Techniques for electronic devices including medical devices and non-medical devices are described. An example method includes performing, via an adapter device (e.g., a connector), a wired-to-wireless conversion (e.g., a USB-to-NFC conversion) for wired signals (e.g., USB signals). In some implementations, the wired signals are converted to wireless signals (e.g., NFC signals). In particular cases, a wireless-to-wired conversion (e.g., an NFC-to-USB conversion) is performed via the adapter device to convert wireless signals (e.g., NFC signals) to wired signals (e.g., USB signals).

### CROSS-REFERENCE TO RELATED APPLICATION

This patent application claims the benefit of and priority to U.S. Provisional Patent Application No. 63/514,193, filed on Jul. 18, 2023, entitled “SYSTEMS AND METHODS OF UTILIZING ADAPTER FACILITATED CONVERSIONS FOR SECURE COMMUNICATIONS BETWEEN DEVICES,” the disclosure of which is hereby incorporated herein by reference.

### BACKGROUND

Various types of devices, such as monitors, defibrillators, health devices, diagnostic devices, field-deployable devices, and other medical and non-medical devices of various types of widespread usage are increasingly being employed for various purposes. Such devices often include coupling capabilities that enable the devices to pair with other devices, instruments, and peripherals of various types. The devices being communicatively coupled with the other devices, instruments, and peripherals enable the devices to gain additionally types of functionality. The communicative coupling utilized by some of the devices includes wired coupling and/or wireless coupling.

### BRIEF DESCRIPTION OF THE DRAWINGS

FIG. 1 illustrates an example environment in which a monitoring device is interconnected with a medical device, the monitoring device being communicatively coupled to the medical device via a connector that is utilized to convert between signals compatible with various communication protocols.

FIG. 2 illustrates an example environment in which a device, including a monitoring device with a universal serial bus (USB) device, is utilized to establish communications utilizing a near field communication (NFC) compatible connector, the USB device being interconnected with the NFC compatible connector.

FIG. 3 illustrates an example signal flow for establishing, for a device, including a monitoring device, a communication connection with a medical device, the communication connection enabling communications to be exchanged between the monitoring device and the medical device via a connector that is utilized to convert between various communication protocols.

FIGS. 4 and 5 illustrates example processes for utilizing conversions between multiple communication protocols for secure communications between devices.

FIG. 6 illustrates an example of an external defibrillator configured to perform various functions described herein.

FIG. 7 illustrates an example of a defibrillator pad cable connector configured to be coupled to a monitoring device with a universal serial bus (USB) device, via a near field communication (NFC) compatible connector.

### DETAILED DESCRIPTION

Various implementations described herein relate to techniques for utilizing adapter facilitated conversions between signals in conformance with multiple communication protocols for secure communications between devices, such as medical devices. In particular cases, the communication protocols include a wired communication protocol and a wireless communication protocol. In some examples, the wired communication protocol includes a universal serial bus (USB) protocol. In those or other examples, the wireless communication protocol includes a near field communication (NFC) communication protocol. In those or other examples, the conversions include a USB-to-NFC conversion for USB signals being converted to NFC signals, and an NFC-to-USB conversion for NFC signals being converted to USB signals. In particular cases, the adapter facilitated conversion is performed utilizing a device, including a communication protocol conversion capable adapter device. In particular cases, the devices include a monitoring device and a medical device. In some cases, the devices include non-medical devices.

Various devices (e.g., electronic devices) include communications connection devices, which are compatible with different communication protocols, and which are configured to be utilized to exchange different communication types. In particular examples, a monitor-defibrillator is capable of communicating with an external device using a particular communication protocol. However, in some cases, the monitor-defibrillator is incapable of communicating using another communication protocol. For instance, the monitor-defibrillator may be able to use a wired communication protocol, but is unable to use a wireless communication protocol.

In particular examples, a mobile device (e.g., a mobile phone, a tablet computer, an external lead) is incompatible with the wired communication protocol, but can communicate via the wireless communication protocol. Thus, in these examples, the monitor-defibrillator and the mobile device may be unable to exchange communications.

In various implementations of the present disclosure, an adapter device is utilized to facilitate communications between otherwise incompatible devices, such as the monitor-defibrillator and the mobile device. In particular examples, the monitor-defibrillator is configured to pair with the mobile device via the adapter device. For instance, the adapter device is capable of converting a signal transmitted by the monitor-defibrillator in conformance with the wired communication protocol, and routing the signal in conformance with the wireless communication protocol to the mobile device, or vice versa. Thus, the adapter device is configured to enable communication between the monitor-defibrillator and the mobile device.

According to those or other implementations of the present disclosure, the monitor-defibrillator includes a port and/or connector, or any other type of communications connection device, that the monitor-defibrillator uses to output a wired signal. In those or other examples, the monitor-defibrillator includes a transceiver, such as a wired communication transceiver (or “wired transceiver”) (e.g., a transceiver compatible with a wired protocol). For instance, the wired transceiver includes a universal serial bus (USB) transceiver (e.g., a transceiver compatible with a USB protocol), or any other type of wired transceiver (e.g., a transceiver compatible with any other type of wired protocol).

According to those or other implementations of the present disclosure, the mobile device includes another connector, or any other type of communications connection device that the mobile device uses to output the wireless signal. In those or other examples, the mobile device includes another transceiver, such as a wireless communication transceiver (or “wireless transceiver”) (e.g., a transceiver compatible with a wireless protocol) (e.g., a radio frequency (RF) transceiver (e.g., a transceiver compatible with an RF protocol)). For instance, the mobile device includes a near field communication (NFC) transceiver (e.g., a transceiver compatible with an NFC protocol), or any other type of wireless transceiver (e.g., a transceiver compatible with any other type of wireless protocol).

Implementations of the present disclosure are directed to improvements in the technical field of electronic devices, including medical devices and/or non-medical devices. Rather than requiring complex and/or cumbersome configurations, assemblies, and interconnections of multiple devices, implementations described herein enable utilization of multiple protocols for simplified and automated pairing and exchanging of communications. In some cases, the electronic devices, which include a transceiver being compatible with a wired protocol, the transceiver not being compatible with a wireless protocol, utilize the adapter device to pair with the other electronic devices, which enables convenient, quick, reliable, and simple pairing between the electronic devices and the other electronic devices.

In contrast to devices being unable to pair and communicate due to incompatible transceivers according to conventional technology, various techniques discussed herein enable electronic devices to pair and communicate with the other electronic devices in a convenient, quick, reliable, and simple way. The electronic devices utilize the adapter devices to pair and communicate with the other electronic devices, which enables the electronic devices to be utilized in various settings, such as medical settings, and particularly in emergency settings including rapid and accurate responses to complex and/or unexpected patient conditions. Rapid and accurate responses enabled via the pairing and communicating of the electronic devices with the other electronic devices increase likelihoods of successful administration of medical treatment to patients.

Various examples will now be described with reference to the accompanying drawings.

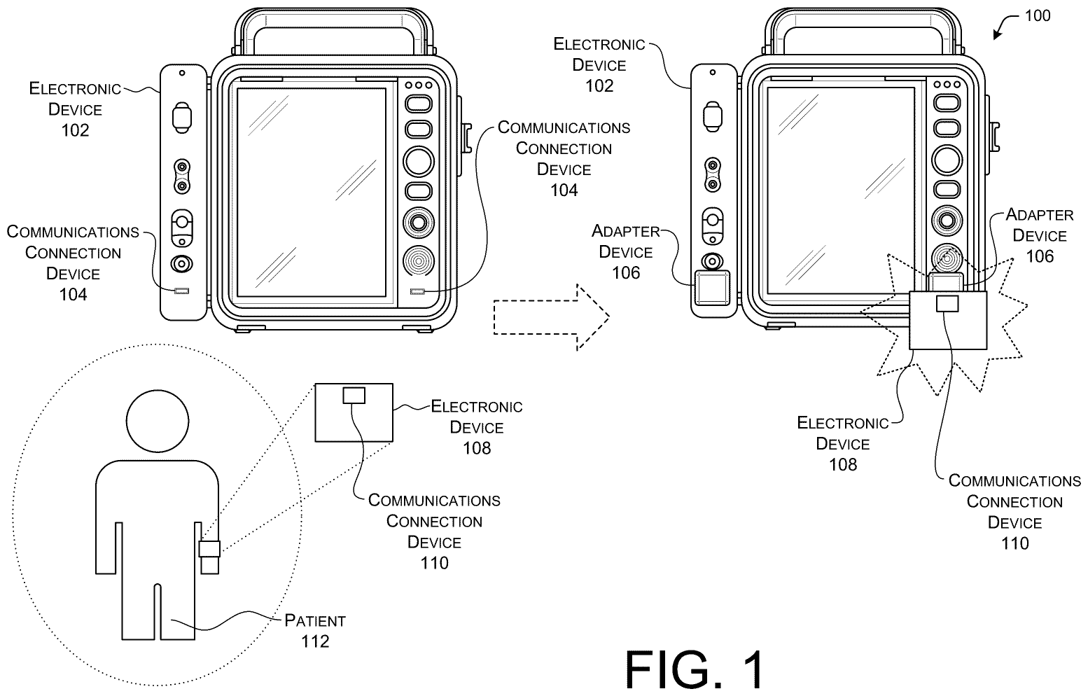

FIG. 1 illustrates an example environment in which a monitoring device is interconnected with a medical device, the monitoring device being communicatively coupled to the medical device via a connector that is utilized to convert between signals compatible with various communication protocols.

In various implementations, an electronic device 102, such as the monitoring device, includes a communications connection device 104. In some examples, the communications connection device 104 is compatible with an adapter device 106, such as the connector. In those or other examples, the electronic device 102 is interconnected with an electronic device 108, such as the medical device. In various implementations, the electronic device 108 includes a communications connection device 110.

In some examples, the electronic device 102 is interconnected with an electronic device 108, via the adapter device 106. In those or examples, the communications connection device 104 interconnected with the communications connection device 110, via the adapter device 106.

In some cases, compatibility between the communications connection device 104 and the adapter device 106 includes electrical compatibility, physical compatibility, or any combination thereof. In those or other cases, the compatibility includes the communications connection device 104 and the adapter device 106 being connectible, such as electrical connectable, physical connectable, or any combination thereof.

In some cases, compatibility between the communications connection device 110 and the adapter device 106 includes electrical compatibility, any other type of compatibility, or any combination thereof. In those or other cases, the compatibility includes the communications connection device 110 and the adapter device 106 being connectible, such as electrical connectable, any other type of compatibility, or any combination thereof.

In some examples, the communications connection device 104 includes a transceiver, such as a wired communication transceiver (or “wired transceiver”). In those or other examples, the wired transceiver included in the communications connection device 104 is compatible with a protocol (e.g., a technology), such as a wired communications protocol (or “wired protocol”). For instance, the wired transceiver included in the communications connection device 104 includes a universal serial bus (USB) transceiver (e.g., a transceiver compatible with a USB protocol). However, in another instance, the wired transceiver included in the communications connection device 104 includes a recommended standard (RS)-232 transceiver (e.g., a transceiver compatible with an RS-232 protocol), an RS-485 transceiver (e.g., a transceiver compatible with an RS-485 protocol), an ethernet transceiver (e.g., a transceiver compatible with an ethernet protocol), an inter-integrated circuit (I2C) transceiver (e.g., a transceiver compatible with an I2C protocol), a serial parallel interface (SPI) transceiver (e.g., a transceiver compatible with an SPI protocol), a 1-wire transceiver (e.g., a transceiver compatible with a 1-wire protocol), a serial advanced technology attachment (SATA) transceiver (e.g., a transceiver compatible with a SATA protocol), or any other type of wired transceiver (e.g., a transceiver compatible with any other type of wired communication protocol).

In some examples, the communications connection device 110 includes a transceiver (e.g., a transceiver including one or more antennas), such as a wireless communication transceiver (or “wireless transceiver”). In those or other examples, the wireless transceiver included in the communications connection device 110 is compatible with a wireless communications protocol (or “wireless protocol”) (e.g., an RF communication protocol) (e.g., a short-range communications protocol). For instance, the other wireless transceiver included in the communications connection device 110 includes a near field communication (NFC) transceiver (e.g., a transceiver compatible with an NFC protocol). However, in another instance, the wireless transceiver included in the communications connection device 110 includes a bluetooth transceiver (e.g., a transceiver compatible with a BLUETOOTH™ protocol), a BLUETOOTH™ low energy (BLE) transceiver (e.g., a transceiver compatible with a BLE protocol), an ultrasonic transceiver (e.g., a transceiver compatible with a ultrasonic protocol), a zigbee transceiver (e.g., a transceiver compatible with an zigbee protocol), a wi-fi transceiver (e.g., a transceiver compatible with an a wi-fi protocol), or an institute of electrical and electronics engineers (IEEE) 802.15.4 (e.g., a transceiver compatible with an IEEE 802.15.4 protocol) transceiver, a z-wave transceiver (e.g., a transceiver compatible with a z-wave protocol), or any other type of wireless transceiver (e.g., a transceiver compatible with any other type of wireless communication protocol).

In various examples, the adapter device 106 includes a transceiver, such as another wired transceiver. For instance, the other wired transceiver included in the adapter device 106 includes a USB transceiver (e.g., a transceiver compatible with a USB protocol). However, in another instance, the wired transceiver included in the adapter device 106 includes an RS-232 transceiver (e.g., a transceiver compatible with an RS-232 protocol), an RS-485 transceiver (e.g., a transceiver compatible with an RS-485 protocol), an ethernet transceiver (e.g., a transceiver compatible with an ethernet protocol), an I2C transceiver (e.g., a transceiver compatible with an I2C protocol), a SPI transceiver (e.g., a transceiver compatible with an SPI protocol), a 1-wire transceiver (e.g., a transceiver compatible with a 1-wire protocol), a SATA transceiver (e.g., a transceiver compatible with a SATA protocol), or any other type of wired transceiver (e.g., a transceiver compatible with any other type of wired communication protocol).

In various examples, the adapter device 106 includes a transceiver, such as another wireless transceiver (e.g., another wireless transceiver including one or more other antennas). For instance, the other wireless transceiver included in the adapter device 106 includes an NFC transceiver (e.g., a transceiver compatible with an NFC protocol). However, in another instance, the other wireless transceiver included in the adapter device 106 includes a bluetooth transceiver (e.g., a transceiver compatible with a bluetooth protocol), a BLE transceiver (e.g., a transceiver compatible with a BLE protocol), an ultrasonic transceiver (e.g., a transceiver compatible with a ultrasonic protocol), a zigbee transceiver (e.g., a transceiver compatible with an zigbee protocol), a wi-fi transceiver (e.g., a transceiver compatible with an a wi-fi protocol), or an IEEE 802.15.4 (e.g., a transceiver compatible with an IEEE 802.15.4 protocol) transceiver, a z-wave transceiver (e.g., a transceiver compatible with a z-wave protocol), or any other type of wireless transceiver (e.g., a transceiver compatible with any other type of wireless communication protocol).

In some implementations, the adapter device 106 is utilized to communicate (e.g., exchange communications) using signals (e.g., communication signals) that are compatible with various communication protocols, which includes converting between the signals that are compatible with the various communication protocols. In various examples, the communication protocols with which the adapter device 106 is compatible include the wired communication protocol and the wireless communication protocol. For instance, the adapter device 106 is compatible with the USB protocol, via the USB transceiver in the adapter device 106, and the NFC protocol, via the NFC transceiver in the adapter device 106.

In some instances, by utilizing the adapter device 106, with the wired transceiver, such as the USB transceiver, and the wireless transceiver, such as the NFC transceiver, the signals are exchanged between the electronic device 102 and the electronic device 108. For example, the signals are exchanged between the electronic device 102 and the electronic device 108, notwithstanding the communications connection device 104 of the electronic device 102 being compatible with the USB protocol and being incompatible with the NFC protocol. In such an example or another example, the signals are exchanged between the electronic device 102 and the electronic device 108, notwithstanding the communications connection device 110 of the electronic device 108 being compatible with the NFC protocol and being incompatible with the USB protocol.

In various implementations, the electronic device 102 includes any of various types of devices, such as one or more medical devices, one or more non-medical devices, or any combination thereof. For instance, the electronic device 102 includes the medical device, which includes a monitor device, a defibrillator device (e.g., a monitor-defibrillator or automated external defibrillator (AED)), a mechanical chest compression device, a ventilation device, a patient monitor, a video laryngoscope, a health device, a diagnostic device, a field-deployable medical device, any other type of medical device, or any combination thereof. In other implementations, the electronic device 102 includes a non-medical device. For instance, the electronic device 102, which includes the non-medical device, includes a mobile device, a payment device, an inventory device, a record keeping device, an employee badge device, a field-deployable non-medical device, any other type of non-medical device, or any combination thereof.

In various implementations, the electronic device 108 includes any of various types of devices, such as one or more other medical devices, one or more other non-medical devices, or any combination thereof. For instance, the electronic device 108, which includes the other medical device, includes a sensor, a wireless sensor, a modular sensor, a peripheral, a wireless peripheral, a modular peripheral, a cable, a wireless cable, a modular cable, a connector, a wireless connector, a modular connector, a lead, a wireless lead, a modular lead, any other type of medical device, or any combination thereof.

In some cases, for example with the electronic device 108 including the other medical device, the electronic device 108 includes a medical sensor. For instance, the electronic device 108, which includes the medical sensor associated with the electronic device 108, includes a physiological data device (e.g., one or more physiological data sensors), a CPR feedback device (e.g., one or more CPR feedback sensors), any other type of medical sensor, or any combination thereof.

In various examples the physiological data sensor is utilized to capture physiological data associated with physiological conditions of a patient 112. In those or other examples, the physiological data includes physiological parameters of the patient 112. Examples of physiological parameters include, for instance, an electrocardiogram (ECG or EKG), an impedance, a force administered to the patient 112, a blood pressure, an airway parameter (e.g., a partial pressure of carbon dioxide, a partial pressure of oxygen, a capnography, an end tidal gas parameter, a flow rate, etc.), a blood oxygenation (e.g., a pulse oximetry value, a regional oximetry value, etc.), an electroencephalogram (EEG), a temperature, a heart sound, a blood flow rate, a physiological geometry (e.g., a shape of a blood vessel, an inner ear shape, etc.), a heart rate, a pulse rate, or the like. For example, the medical sensor in the electronic device 102 includes at least one of electrodes, a detection circuit, defibrillator pads (e.g., one or more defibrillator pads receiving power from a power supply, such as an internal power supply, an external power supply, or a combination thereof), a force sensor, a blood pressure cuff, an ultrasound-based blood pressure sensor, an invasive (e.g., intra-arterial) blood pressure sensor (e.g., including a cannula inserted into the patient 112), a gas sensor (e.g., a carbon dioxide and/or oxygen sensor), a flowmeter, a pulse oximetry sensor, a regional oximetry sensor, a thermometer, a microphone, an ultrasound transducer, a medical imaging device (e.g., an ultrasound imaging device), or the like.

For instance, the electronic device 108, which includes the other medical device, includes a physiological data sensor, the CPR feedback device. In various examples, the CPR feedback device includes sensors (e.g., accelerometers) and measures, via the sensors, a depth of a chest of the patient 112 while a caregiver is administering CPR. In various cases, the CPR feedback devices provides feedback (e.g., real time feedback), such as feedback being provided dynamically, on a quality of the CPR being administered. In some instances, the CPR feedback device includes a “puck” capable of being placed on the patient 112.

In other implementations, the electronic device 108 includes the other non-medical device. For instance, the electronic device 108, which includes the other non-medical device, includes a sensor, a wireless sensor, a modular sensor, a peripheral, a wireless peripheral, a modular peripheral, a cable, a wireless cable, a modular cable, a connector, a wireless connector, a modular connector, a lead, a wireless lead, a modular lead, any other type of non-medical device, or any combination thereof.

In some cases, for example with the electronic device 108 including the other non-medical device, the electronic device 108 includes a non-medical sensor. For instance, the electronic device 108, which includes the non-medical sensor associated with the electronic device 108, includes an asset tracking sensor associated with an asset (e.g., item), a product sensor associated with a product, a package sensor associated with a package, a warehouse sensor associate with a warehouse (e.g., a location in a warehouse), a retail sensor, a logistical sensor, a badge sensor (e.g., an employee badge sensor), a location sensor (e.g., a global positioning system (GPS) sensor), a payment sensor associated with a payment (e.g., a payment transaction) of an item, a purchase sensor associated with a purchase of an item, a price sensor associated with a price of an item, a tracking sensor, an item identifier sensor associated with an item (e.g., an object, any other type of item, or any combination thereof), a user identifier sensor associated with a user (e.g., a person, an employee, a patient, a caregiver, any other type of user, or any combination thereof), a network identifier sensor associated with a network, a network adapter identifier sensor (e.g., a cellular network adapter identifier sensor, a wi-fi network adapter identifier sensor, any other type of network adapter identifier sensor associated with any other type of network, or any combination thereof), a network identifier sensor (e.g., a cellular network identifier sensor, a wi-fi network identifier sensor, any other type of network identifier sensor associated with any other type of network, or any combination thereof), a device sensor (e.g., an electronic device sensor, an internet of things (IoT) device sensor, a computing sensor, a desktop computer sensor, a laptop sensor, a tablet sensor, a personal digital assistant (PDA) sensor, an electronic book device sensor, a server sensor, a workstation sensor, an audio device sensor, or any other device sensor associated with any other type of device, or any combination thereof), a phone sensor (e.g., a cellular phone sensor) associated with a phone, a camera sensor associated with a camera, an instrument sensor (e.g., a field-device sensor, an electronic instrument sensor, any other type of instrument sensor, or any combination thereof, an electronic stereo sensor, an audio instrument sensor, an electronic speaker sensor, any other type of instrument sensor associated with any other type of instrument, or any combination thereof), a vehicle sensor associated with a vehicle, a parking sensor associated with a parking location, any other type of non-medical sensor, or any combination thereof.

In various cases, the electronic device 102 includes the communications connection device 104, which includes a port (e.g., a receptacle) (e.g., a female connector). For example, the port is compatible with the adapter device 106 (e.g., with the communications connection device 110). In some cases, the transceiver, such as the wired transceiver, of the communications connection device 104 is included in the communications connection device 104 as the port. However, in an alternative example, the communications connection device 104 includes the wired transceiver as a plug (e.g., a male connector).

In various cases, the adapter device 106 includes the communications connection device 110, which includes a plug (e.g., a male connector). For example, the plug is compatible with the electronic device 102 (e.g., with the communications connection device 104). In some cases, the other transceiver, such as the other wired transceiver, of the adapter device 106 is included in the adapter device 106 as the plug. However, in an alternative example such as for instances in which the communications connection device 104 includes the plug, the adapter device 106 includes the other wired transceiver as a port (e.g., a receptacle) (e.g., a female connector).

In various implementations, the adapter device 106 is connected to the electronic device 102. In some cases, the adapter device 106 being connected to the electronic device 102 includes the adapter device 106 being physically connected, electrically connected (e.g., connected for exchanging data, power, or any combination thereof), and communicatively connected (e.g., connected for exchanging communication signals (or “signals”)) (e.g., messages), to the electronic device 102. For instance, the adapter device 106 is plugged into the electronic device 102, by being inserted into the electronic device 102. In such an instance or another instance, the adapter device 106 being inserted into the electronic device 102 includes the plug of the adapter device 106 being inserted into the port of the electronic device 102 (e.g., being inserted into the port of the communications connection device 104). In such an instance or another instance, the plug includes of the adapter device 106 includes a USB compatible plug (or “USB plug”), which is inserted into the port of the communications connection device 104, the port of the communications connection device 104 including a USB compatible port (or “USB port”).

In some examples, the communication signals include signals that encode data, which are further encrypted, or not further encrypted. The data, for instance, indicates a physiological parameter, a treatment, an instruction, or other event detected by a transmitting device (e.g., the electronic device 102, the electronic device 108, etc.).

In various implementations, the adapter device 106 is communicatively connected to the electronic device 110 in response to the adapter device 106 being initialized (e.g., initialized for a communicative connection with the electronic device 102). In some examples, the adapter device 106 is initialized by operations (or “actions”) (e.g., initialization operations or “initialization”) being performed in response to the electronic device 102 detecting a connection with the adapter device 106. In various cases, the electronic device 102 detecting the connection between the adapter device 106 and the electronic device 102 includes the electronic device 102 performing wired device detecting operations (or “wired detecting”). In those examples or other examples, detecting the connection between the adapter device 106 and the electronic device 102 includes detecting an electrical connection between the adapter device 106 and the electronic device 102.

In various cases, detecting the electrical connection between the adapter device 106 and the electronic device 102 includes the adapter device 106 being physically connected to (e.g., plugged into) the electronic device 102. In those or other instances, detecting the electrical connection between the adapter device 106 and the electronic device 102 includes the adapter device 106 being electrically connected to the electronic device 102, in response to the adapter device 106 being physically connected to the electronic device 102.

In some examples, the electronic device 102 supplies power to the adapter device 106 in response to the adapter device 106 being electrically connected to the electronic device 102. In those or other examples, the electronic device 102 exchanges communications with the adapter device 106 in response to the adapter device 106 being electrically connected to the electronic device 102. For instance, with examples in which the adapter device 106 receives power from, and exchanges communications with (e.g., exchanges communications via signals utilized to transfer power, data, or any combination thereof), the electronic device 102, the power is received via power pins, such as a power pin of the adapter device 106. In such an instance or another instance, the data is exchanged by data pins, such as a data pin of the adapter device 106 that is recessed with respect to the power pin to enable power to be received by the adapter device 106 prior to a data connecting being established between the electronic device 102 and the adapter device 106 (e.g., the data pin is recessed with respect to the power pin to enable power to be received by the adapter device 106 prior to data being exchanged between the adapter device 106 and the electronic device 102).

In some cases, establishing the communicative connection between the electronic device 102 and the adapter device 106 includes the electronic device 102 identifying electrical characteristics of the adapter device 106, as identified electrical characteristics. For example, an electrical characteristic of the adapter device 106 is detected by the electronic device 102 and utilized by the electronic device 102 to identify the adapter device 106 as being electrically connected to the electronic device 102. In some instances, the electrical characteristics include electrical potentials (e.g., voltage values) of data lines, such as a potential of a data line connected to, and utilized by, the electronic device 102 to identify the adapter device 106 as being electrically connected. For instance, the data line being “pulled to a level” (e.g., “pulled to a high level”) is utilized by the electronic device 102 to identify the adapter device 106 as being electrically connected to the electronic device 102.

In some examples, communication signals are exchanged between the electronic device 110 and the adapter device 106 in response to the adapter device 106 being connected to the electronic device 102. In some implementations, the communication signals (e.g., the adapter device related signals) are exchanged between the electronic device 102 and the adapter device 106 via wired/wireless conversion. In various cases, the wired/wireless conversion includes wired signal and wireless signal conversion (e.g., USB signal and NFC signal conversion), wired protocol and wireless protocol conversion (e.g., USB protocol and NFC protocol conversion), or any combination thereof.

In some cases, establishing the communicative connection (e.g., establishing the physical connection and the electrical connection) between the electronic device 102 and the adapter device 106 is utilized by the electronic device 102 and the adapter device 106 to exchange the communication signals, such as adapter device related signals. In those or other examples, the adapter device related signals include adapter device related data.

In various examples, the adapter device related signals include signals transmitted by the electronic device 102. For example, electronic device signals (e.g., signals transmitted by the electronic device 102) include the signals that are in the adapter device related signals and that are transmitted by the electronic device 102. In some cases, the signals that are in the adapter device related signals and that are transmitted by the electronic device 102 include request signals.

For instance, the request signals are utilized by the electronic device 102 to request description data (e.g., description data, such as device descriptors) from the adapter device 106. For example, the request signals are utilized by the electronic device 102 to query the adapter device 106 for the description data (e.g., the description data, which is associated with, and provided by, the adapter device 106), device structure data (e.g., structure data associated with, and provided by, the adapter device 106), any other types of data associated with the adapter device 106, or any combination thereof.

In various implementations, the adapter device related signals include signals transmitted by the adapter device 106. For example, adapter device signals (e.g., signals transmitted by the adapter device) include the signals that are in the adapter device related signals and that are transmitted by the adapter device 106. In some cases, the signals that are in the adapter device related signals and that are transmitted by the adapter device 106 include adapter device capabilities data signals (or “adapter device capabilities signals”).

For instance, the adapter device capabilities signals are associated with adapter device capabilities. In some cases, the adapter device capabilities signals are utilized by the electronic device 102 to identify the adapter device capabilities data. In those and other examples, the adapter device capabilities signals are provided by the adapter device 106 and to the electronic device 102.

In some cases, adapter device related data includes adapter device capabilities data (or “capabilities data”) in the adapter device capabilities signals. For example, the adapter device capabilities data is associated with capabilities of the adapter device 106 with respect to the wired protocol (e.g., communication via the wired protocol, such as the USB protocol), the wireless protocol (e.g., communication via the wireless protocol, such as the NFC protocol), or any combination thereof. In various cases, the adapter device capabilities data includes wired/wireless communicating assisting capabilities data (e.g., USB/NFC communicating assisting capabilities data).

In various cases, adapter device related data include adapter device compatibility data (or “compatibility data”). In some examples, the adapter device compatibility data is managed (e.g., identified, determined, received, etc.) via the adapter device related signals. In those or other examples, the compatibility data includes wired protocol compatibility data (e.g., USB compatibility data) indicating compatibility of the adapter device 106 with the wired protocol (e.g., the USB protocol). In those or other examples, the compatibility data includes wireless protocol compatibility data (or “compatibility data”) (e.g., NFC compatibility data) indicating compatibility of the adapter device 106 with the wireless protocol (e.g., the NFC protocol). In various cases, the adapter device compatibility data includes wired/wireless communicating assisting compatibility data (e.g., USB/NFC communicating assisting compatibility data).

In some examples, the adapter device related signals include configuration signals, initialization signals, setup signals, any other types of adapter device related signals, or any combination thereof. In those or other examples, the configuration signals are associated with adapter device related configurations. In those or other examples, the initialization signals are associated with the adapter device related initializations. In those or other examples, the setup signals are associated with the adapter device related setup operations.

In some examples, the adapter device related data includes various types of data utilized for adapter device related operations (e.g., the adapter device related configurations, the adapter device related initializations, the adapter device related initializations, etc.). For instance, the adapter device related data includes configuration data in the configuration signals, initialization data in the initialization signals, setup data in the setup signals, any other types of data in the other corresponding adapter device related signals, or any combination thereof.

In some cases, the adapter device related signals (e.g., adapter device capabilities signals, the request signals, the configuration signals, the initialization signals, the setup signals, other adapter device related signals, or any combination thereof) are associated with (e.g., are exchanged in response to, or are exchanged to initiate performance of) the adapter device related operations. For instance, the adapter device related operations are performed by the electronic device 102, the adapter device 106, or any combination thereof. In various cases, the adapter device related operations are utilized for establishing communications between the electronic device 102 and the adapter device 106.

In some examples, the adapter device related operations include various types of operations (or “adapter device related electronic device operations”) performed by the electronic device 102. In those or other examples, electronic device operations (e.g., operations performed by the electronic device 102) include the operations that are included in the adapter device related operations and that are performed by the electronic device 102. In those or other examples, wired/wireless operations (e.g., operations performed utilizing the wired protocol and the wireless protocol) include the electronic device operations.

In those or other examples, the operations that are included in the adapter device related operations and that are performed by the electronic device 102 include configuration operations (or “configurations”) (e.g., configuration operations associated with configuration of the adapter device 106), initialization operations (or “initializations”) (e.g., initialization operations associated with initialization of the adapter device 106), setup operations (or “setups”) (e.g., setup operations associated with setup of the adapter device 106), any other adapter device related electronic device operations, or any combination thereof.

In various implementations, the adapter device related operations include various types of operations (e.g., adapter device assisting operations (or “assisting operations”)) performed by the adapter device 106. In some examples, adapter device operations (e.g., operations performed by the adapter device 106) include the operations (e.g., assisting operations) that are included in the adapter device related operations and that are performed by the adapter device 106. In those or other examples, the assisting operations include configuration assisting operations, initialization assisting operations, setup assisting operations, any other assisting operations, or any combination thereof.

In some cases, the adapter device related operations (e.g., the adapter device related electronic device operations, the assisting operations, etc.) are performed to enable the adapter device 106 to be identified by, configured, initialized, setup, and communicatively connected to, the electronic device 102. In those or other examples, the adapter device related data (e.g., the capabilities data, the compatibility data, the configuration data, the initialization data, the setup data, any other types of data in corresponding adapter device related signals, or any combination thereof) is utilized for performance of the adapter device related operations.

In various cases, the electronic device 102 utilizes adapter device drivers to identify the adapter device 106 as being compatible with the wireless protocol (e.g., the NFC protocol). For example, the electronic device 102 identifies adapter device drivers in response to the adapter device related signals, the adapter device related data, or any combination thereof.

In some implementations, the adapter device drivers are utilized to establish the communication connection between the electronic device 102 and the adapter device 106. In various cases, the electronic device 102 utilizes adapter device drivers operations to identify the adapter device drivers. For instance, identifying the adapter device drivers includes loading the adapter device related data, storing the adapter device related data (e.g., storing the adapter device related data in the storage device of the electronic device 102), installing the adapter device related data, performing any other adapter device drivers operations (e.g., adapter device drivers operations associated with the adapter device related signals, the adapter device related data, or any combination thereof), or any combination thereof.

In various cases, the adapter device related signals are utilized by the electronic device 102 to manage (e.g., to perform various operations associated with the adapter device drivers) the adapter device drivers in various ways. For instance, with examples in which the adapter device related signals are received by the electronic device 102, the electronic device 102 performs adapter device drivers operations. In some cases, the electronic device operations include operations that are included in the adapter device drivers operations and that are performed by the electronic device 102.

In some examples, the adapter device drivers operations include identifying adapter device drivers, loading the adapter device drivers, storing the adapter device drivers (e.g., storing the adapter device drivers in the storage device of the electronic device 102), installing the adapter device driver, performing any other operations associated with the adapter device drivers, or any combination thereof, in response to the adapter device related signals. In those or other examples, the electronic device 102 performs any of the adapter device drivers operations utilizing the adapter device capabilities signals, any other adapter device related signals being provided by the adapter device 106 and received by the electronic device 108, or any combination thereof.

In various implementations, the adapter device drivers are utilized by the electronic device 102 to enable, activated, control, etc., the adapter device 106 to assist in operations (e.g., the electronic device operations) performed by the electronic device 102. In those or other examples, adapter device operations, which are utilized by the adapter device 106 to assist in the electronic device operations, include wired/wireless assisting operations. For instance, the wired/wireless operations include the wired/wireless assisting operations.

In some cases, the wired/wireless operations performed by the electronic device 102 include conversion operations, detection operations, pairing operations, communicating operations, any other wired/wireless operations of various types, or any combination thereof. In some cases, the wired/wireless assisting operations performed by the adapter device 106 include conversion assisting operations, detection assisting operations, pairing assisting operations, communicating assisting operations, any other wired/wireless assisting operations of various types, or any combination thereof.

While any of the electronic device operations, any of the wired/wireless operations, or any combination thereof, are performed by the electronic device 102, as discussed above in the current disclosure, it is not limited as such. In some examples, the electronic device operations, any of the wired/wireless operations, or any combination thereof, are performed by the electronic device 102, the adapter device 106, or any combination thereof.

In some implementations, the electronic device 102 and the adapter device 106 are enabled, activated, controlled, etc., in response to the adapter device drivers. In some examples, the electronic device 102 and the adapter device 106 are enabled, activated, controlled, etc., to perform the wired/wireless converting operations and the wired/wireless converting assisting operations, respectively. In those or other examples, the electronic device 102 and the adapter device 106 are enabled, activated, controlled, etc., to perform the wired/wireless detecting operations and the wired/wireless detecting assisting operations, respectively. In those or other examples, the electronic device 102 and the adapter device 106 are enabled, activated, controlled, etc., to perform the wired/wireless pairing operations and the wired/wireless pairing assisting operations, respectively. In those or other examples, the electronic device 102 and the adapter device 106 are enabled, activated, controlled, etc., to perform the wired/wireless communicating operations and the wired/wireless communicating assisting operations, respectively. In those or other examples, the electronic device 102 and the adapter device 106 are enabled, controlled, activated, etc., to perform any other types of wired/wireless operations, including wired/wireless electronic device operations and wired/wireless adapter device operations, respectively, in response to the adapter device drivers.

In some examples, the adapter device drivers are utilized by the electronic device 102 to enable, activated, control, etc., the adapter device 106 to assist in the wired/wireless converting operations (or “converting operations”) (or “wired/wireless converting”) (e.g., USB/NFC converting operations (or “USB/NFC converting”). In those or other examples, the adapter device drivers include a device driver that is utilized by the electronic device 102 to enable the adapter device 106 to assist in the converting operations.

In some examples, the adapter device drivers are utilized by the electronic device 102 to enable, activated, control, etc., the adapter device 106 to assist in the wired/wireless detecting operations (or “detecting operations”) (or “wired/wireless detecting”) (e.g., detecting, which includes the wired/wireless converting) (e.g., USB/NFC detecting operations (or “USB/NFC detecting”). In those or other examples, the adapter device drivers include a device driver that is utilized by the electronic device 102 to enable the adapter device 106 to assist in the detecting operations.

In various examples, the adapter device drivers are utilized by the electronic device 102 to enable, activated, control, etc., the adapter device 106 to assist in the wired/wireless pairing operations (or “pairing operations”) (or “pairing”) (e.g., pairing, which includes the wired/wireless converting) (e.g., USB/NFC pairing operations (or “USB/NFC pairing”). In some examples, the adapter device drivers include a device driver (or “driver”) that is utilized by the electronic device 102 to control, enable, etc., the adapter device 106 to assist in pairing operations. In those or other examples, the adapter device drivers include a device driver that is utilized by the electronic device 102 to enable the adapter device 106 to assist in the pairing operations.

In various examples, the adapter device drivers are utilized by the electronic device 102 to enable, activated, control, etc., the adapter device 106 to assist in the wired/wireless communicating operations (or “communicating operations”) (or “communicating”) (e.g., communicating, which includes the wired/wireless converting) (e.g., USB/NFC communicating operations (or “USB/NFC communicating”). In those or other examples, the adapter device drivers include a device driver that is utilized by the electronic device 102 to enable the adapter device 106 to assist in wireless device the communicating operations.

While the adapter device drivers utilized to enable, activate, control, etc., the electronic device 102 and the adapter device 106 are separate from one another, as discussed above in the current disclosure, it is not limited as such. In some examples, any of the adapter device drivers are combined with (e.g., integrated together with) any of the other adapter device drivers, for purposes of enabling, activating, controlling, etc., the electronic device 102 and the adapter device 106 for performing any of the corresponding functions.

In some implementations, activation, which includes activation (or “adapter device activation”) of the adapter device 106, is performed. In various examples, the activation includes activating operations being performed by the electronic device 102, the adapter device 106, or any combination thereof, to activate the adapter device 106 for adapter device operations. In various examples, the activating operations are performed in response to the connection (e.g., the physical connection and the electrical connection between the electronical device 102 and the adapter device 106), the identified electrical characteristics, the adapter device related signals, the adapter device related data, the adapter device drivers, the adapter device related operations etc., or any combination thereof.

In some cases, the activating operations include electronic device activating operations and adapter device activating operations. In those or other examples, the electronic device activating operations include operations (e.g., operations in the electronic device operations utilized for activation) that are performed to activate the electronic device 102, such as to perform the electronic device operations associated with electronic device activation. In those or other examples, the adapter device activating operations include operations (e.g., operations in the adapter device operations utilized for activation) that are performed to activate the adapter device 106, such as to perform the adapter device operations associated with adapter device activation.

In various cases, the adapter device 106 is enabled, activated, etc., to perform individual ones of the assisting operations in response to successful completion of activation of the corresponding assisting operations. In some examples, the electronic device activation includes wired/wireless converting operations activation, wired/wireless detecting operations activation, wired/wireless pairing operations activation, wired/wireless communicating operations activation, any other adapter device activation operations (e.g., activation of any other any other assisting operations), or any combination thereof. In those or other examples, the adapter device activation includes wired/wireless converting assisting operations activation, wired/wireless detecting assisting operations activation, wired/wireless pairing assisting operations activation, wired/wireless communicating assisting operations activation, any other adapter device activation operations (e.g., activation of any other any other assisting operations), or any combination thereof.

In some examples, the electronic device 102 is enabled, activated, etc., to perform wired/wireless converting operations in response to completion of the wired/wireless converting operations activation (e.g., activation of wired/wireless converting operations) (e.g., successful completion of wired/wireless converting activation operations). In those or other examples, the adapter device 106 is enabled, activated, etc., to perform the wired/wireless detecting operations in response to completion of the wired/wireless detecting operations activation (e.g., activation of wired/wireless detecting operations) (e.g., successful completion of wired/wireless detecting activation operations). In those or other examples, the adapter device 106 is enabled, activated, etc., to perform the wired/wireless pairing operations in response to completion of the wired/wireless pairing operations activation (e.g., activation of the wired/wireless pairing operations) (e.g., successful completion of wired/wireless pairing activation operations). In those or other examples, the adapter device 106 is enabled, activated, etc., to perform wired/wireless communicating operations in response to completion of wired/wireless communicating operations activation (e.g., activation of the wired/wireless communicating operations) (e.g., successful completion of wired/wireless communicating activation operations).

In some examples, the activation of any the wired/wireless operations is utilized to enable the electronic device 102 to perform the corresponding wired/wireless operations. In those or other examples, the activation of the wired/wireless converting operations is utilized to enable the electronic device 102 to perform the wired/wireless converting operations. In those or other examples, the activation of the wired/wireless detecting operations is utilized to enable the electronic device 102 to perform the wired/wireless detecting operations. In those or other examples, the activation of the wired/wireless pairing operations is utilized to enable the electronic device 102 to perform the wired/wireless pairing operations. In those or other examples, the activation of the wired/wireless communicating operations is utilized to enable the electronic device 102 to perform the wired/wireless converting operations. In those or other examples, the activation of the wired/wireless communicating operations is utilized to enable the electronic device 102 to perform the wired/wireless converting operations. In those or other examples, the activation of any others of the wired/wireless operations is utilized to enable the electronic device 102 to perform any others of the wired/wireless operations.

In some examples, the adapter device 106 is enabled, activated, etc., to perform the wired/wireless converting assisting operations in response to completion of the wired/wireless converting assisting operations activation (e.g., activation of wired/wireless converting assisting operations) (e.g., successful completion of wired/wireless converting assisting activation operations). In those or other examples, the adapter device 106 is enabled, activated, etc., to perform the wired/wireless detecting assisting operations in response to completion of the wired/wireless detecting assisting operations activation (e.g., activation of wired/wireless detecting assisting operations) (e.g., successful completion of wired/wireless detecting assisting activation operations). In those or other examples, the adapter device 106 is enabled, activated, etc., to perform the wired/wireless pairing assisting operations in response to completion of the wired/wireless pairing assisting operations activation (e.g., activation of the wired/wireless pairing assisting operations) (e.g., successful completion of wired/wireless pairing assisting activation operations). In those or other examples, the adapter device 106 is enabled, activated, etc., to perform wired/wireless communicating assisting operations in response to completion of wired/wireless communicating assisting operations activation (e.g., activation of the wired/wireless communicating assisting operations) (e.g., successful completion of wired/wireless communicating assisting activation operations).

In some examples, the activation of any the wired/wireless assisting operations is utilized to enable the adapter device 106 to assist in the corresponding wired/wireless operations being performed by the electronic device 102. In those or other examples, the activation of the wired/wireless converting assisting operations is utilized to enable the adapter device 106 to assist in the wired/wireless converting operations being performed by the electronic device 102. In those or other examples, the activation of the wired/wireless detecting assisting operations is utilized to enable the adapter device 106 to assist in the wired/wireless detecting operations being performed by the electronic device 102. In those or other examples, the activation of the wired/wireless pairing assisting operations is utilized to enable the adapter device 106 to assist in the wired/wireless pairing operations being performed by the electronic device 102. In those or other examples, the activation of the wired/wireless communicating assisting operations is utilized to enable the adapter device 106 to assist in the wired/wireless converting operations being performed by the electronic device 102. In those or other examples, the activation of the wired/wireless communicating assisting operations is utilized to enable the adapter device 106 to assist in the wired/wireless converting operations being performed by the electronic device 102. In those or other examples, the activation of any others of the wired/wireless assisting operations is utilized to enable the adapter device 106 to assist in any others of the wired/wireless operations being performed by the electronic device 102.

In some examples, the electronic device 102 identifies the adapter device 106 as being compatible with the wired protocol (e.g., the USB protocol), the wireless protocol (e.g., the NFC protocol), or any combination thereof, in response to the connection (e.g., the physical connection and the electrical connection between the electronical device 102 and the adapter device 106), the electrical characteristics, the adapter device related signals, the adapter device related data, the adapter device drivers, the adapter device related operations, the activation operations, etc., or any combination thereof.

In some implementations, the electronic device 102 and the adapter device 106 perform various operations in response to the connection (e.g., the physical connection and the electrical connection between the electronical device 102 and the adapter device 106), the electrical characteristics, the adapter device related signals, the adapter device related data, the adapter device drivers, the adapter device related operations, the activation operations, etc., or any combination thereof. For example, the electronic device 102 and the adapter device 106 perform the wired/wireless converting operations and the wired/wireless converting assisting operations, respectively, the wired/wireless detecting operations and the wired/wireless detecting assisting operations, respectively, the wired/wireless pairing operations and the wired/wireless pairing assisting operations, respectively, the wired/wireless communicating operations and the wired/wireless communicating assisting operations, respectively, any of the other wired/wireless operations and any of the other wired/wireless assisting operations, respectively, in response to the connection (e.g., the physical connection and the electrical connection between the electronical device 102 and the adapter device 106), the electrical characteristics, the adapter device related signals, the adapter device related data, the adapter device drivers, the adapter device related operations, the activation operations, etc., or any combination thereof.

In some cases, any of various operations (e.g., the adapter device related operations) (e.g., wired/wireless operations, such as the electronic device operations, the adapter device operations, any other wired/wireless operations, or any combination thereof), are performed in response to the adapter device 106 satisfying various characteristics (e.g., NFC characteristics). For example, any of the various operations (e.g., the adapter device related operations) (e.g., wired/wireless operations, such as the electronic device operations, the adapter device operations, any other wired/wireless operations, or any combination thereof) are performed in response to the adapter device 106 satisfying a power characteristic (e.g., a short-range wireless communication power characteristic), a wavelength characteristic (e.g., a short-range wireless communication wavelength characteristic), a frequency characteristic (e.g., a short-range wireless communication frequency characteristic), or any combination thereof, associated with the wireless protocol (e.g., the electronic device operations are performed utilizing the antenna of the adapter device 106, the antenna including a short-range wireless communication antenna satisfying the short-range wireless communication power characteristic, the short-range wireless communication wavelength characteristic, the short-range wireless communication frequency characteristic, any other wireless protocol characteristic, or any combination thereof, associated with the wireless protocol).

In some instances, any of the various operations (e.g., the adapter device related operations) (e.g., wired/wireless operations, such as the electronic device operations, the adapter device operations, any other wired/wireless operations, or any combination thereof) are performed in response to the adapter device 106 satisfying a short-range wireless communication power characteristic (e.g., an NFC power characteristic, such as a power with a value of 6 milliwatts (e.g., 1 milliwatt, 5 milliwatts, 10 milliwatts, etc., with a variation of 100 microwatts, 1 milliwatt, 5 milliwatts, etc.) and a voltage with a value of 3 volts (e.g., 3 volts with a variation of 0.1 volt, 0.5 volt, etc.)), the short-range wireless communication wavelength characteristic (e.g., an NFC wavelength characteristic, such as a wavelength with a value of 22 meters, with a variation of 1 meter, 2 meters, etc.), the short-range wireless communication frequency characteristic (e.g., an NFC frequency characteristic, such as a frequency with a value in a frequency band (e.g., a frequency with a value in a 13.56 megahertz unlicensed radio frequency industrial, scientific and medical (ISM) band, with a variation of 10 kilohertz, 1 megahertz, etc.)). For example, any of the various operations (e.g., the adapter device related operations) (e.g., wired/wireless operations, such as the electronic device operations, the adapter device operations, any other wired/wireless operations, or any combination thereof) are performed in response to the antenna of the adapter device 106 including the short-range wireless communication power characteristic, the short-range wireless communication wavelength characteristic, the short-range wireless communication frequency characteristic, any other wireless protocol characteristic, or any combination thereof, associated with the wireless protocol.

In various implementations, wireless fields (e.g., a wireless field associated with the electronic device 102, the communications connection device 104, and/or the adapter device 106, a wireless field associated with the electronic device 108, the communications connection device 110, or any combination thereof) are generated in response to the connection (e.g., the physical connection and the electrical connection between the electronical device 102 and the adapter device 106), the identified electrical characteristics, the adapter device related signals, the adapter device related data, the adapter device drivers, the adapter device related operations, activating operations, etc., or any combination thereof. In some cases, any of the various operations (e.g., wired/wireless operations, such as the electronic device operations, the adapter device operations, any other wired/wireless operations, or any combination thereof) are performed utilizing (e.g., in response to) the generation of the wireless fields. In some cases, the electronic device 102 is utilized (e.g., utilized as an “initiator device”), in combination with the adapter device 106, to produce (e.g., generate) a wireless field (e.g., an RF field) (e.g., an NFC field).

For instance, with the electronic device 102 (e.g., the electrical device, the communications connection device 104, the adapter device 106, or any combination thereof) being utilized to generate a wireless field (e.g., an NFC field) via field generation operations included in the wired/wireless operations, the electronic device 102 utilizes (e.g., controls) the adapter device 106 (e.g., the electronic device 102 controls the transceiver (e.g., the antenna) in the adapter device 106) to produce radio signals (e.g., RF signals compatible with the wireless protocol) (e.g., RF signals compatible with the NFC protocol) (e.g., NFC signals).

In some examples, generating the wireless field includes the electronic device 102 utilizing the adapter device 106 to transmit the radio signals, as transmitted signals (e.g., transmitted wireless signals) (e.g., transmitted NFC signals). In those or other examples, the generating of the wireless field includes the electronic device 102 utilizing the adapter device 106 to generate the wireless field (e.g., the NFC field) via the transmitted signals. In those or other examples, wireless fields (e.g., wireless fields including one or more of the wireless field), which are generated by the electronic device 102 and the adapter device 106, create an electromagnetic wave (e.g., electromagnetic radiation). The wireless fields (e.g., the electromagnetic wave/radiation), for example, form a wireless signal (e.g., a radio signal, such as an RF signal) (e.g., an NFC signal).

In some implementations, the generating of the wireless field includes the electronic device 102 transmitting a control signal (e.g., a control signal compatible with the wired protocol) (or “wired control signal”) (e.g., a control signal compatible with the USB protocol) (or “USB control signal”) to the adapter device 106, causing the adapter device 106 to generate the wireless field (e.g., (e.g., the wired control signal causes the adapter device 106 to assist in generation of the wireless field).

In some examples, the adapter device 106 is caused to generate the wireless field (e.g., the wireless field is formed via the wireless signal being emitted by the adapter device 106, such as by the transceiver (e.g., the antenna) of the adapter device 106) in response to the wired control signal (e.g., the USB control signal). In those or other examples, the wireless field is generated in response to power supplied by the electronic device 102 and to the adapter device 106. In some instances, the wireless field, such as the NFC field, is generated by the electronic device 102 being operated in combination with the adapter device 106, as a combined electronic device.

In some implementations, the wireless field is generated in response to the wired control signal, the power (e.g., alternating current (AC) power) (e.g., an AC power signal) (or “power signal”) received from the electronic device 102, or any combination thereof. In various examples, the wired control signal, such as the USB control signal causes the adapter device 106 to utilize the AC power to generate the wireless field (e.g., the wired control signal is utilized to instruct and control the adapter device 106 to generate the wireless field, for instance, with examples in which the control signal is separate from the power signal).

In various cases, the AC signal that is transmitted by the electronic device 102 and to the adapter device 106 is utilized, as the wired control signal, to control the adapter device 106 to generate the wireless field (e.g., the AC signal is utilized as both the power signal and the control signal, as a combined signal) (e.g., the wired control signal is provided via the AC signal). In some examples, the wired control signal, the power signal, or any combination thereof, are communicated from the electronic device 102 and to the adapter device 106, and utilized to generate the wireless field, via the wired/wireless converting (e.g., wired/wireless power signal converting).

In some implementations, various devices (e.g., the electronic device 102, the communications connection device 104, the adapter device 106, the electronic device 108, the communications connection device 110, or any combination thereof) perform the wired/wireless operations, such as the converting, the detecting, the pairing, the communicating, any other wired/wireless operations, or any combination thereof. In various examples, the wired/wireless operations are performed via inductive coupling between the adapter device 106 and the other wireless device (e.g., the electronic device 108 (e.g., the communications connection device 110)).

For instance, with examples in which the wireless device detecting includes the inductive coupling between the adapter device 106 and the electronic device 108, transceivers (e.g., two transceivers (e.g., a transceiver in the adapter device 106 and a transceiver in the communications connection device 110) with two corresponding antennas (e.g., two nearby loop antennas)), form an air-core transformer (or “antenna coil”). In some examples, the air-core transformer is formed in response to the electronic device 108 (e.g., the communications connection device 110) being moved toward the adapter device 106, held in front of the adapter device 106, moved or held in any other way with respect to the adapter device 106, or any combination thereof. In those or examples, the air-core transformer is formed in response to relative movement, or lack thereof, between the adapter device 106 (e.g., the transceiver in the adapter device 106) and the communications connection device 110 (e.g., the transceiver in communications connection device 110), in response to the wire/wireless communications (e.g., the wired communications that are transmitted by the electronic device 102 and converted utilizing the adapter device 106).

In those or other examples, any of the wired/wireless operations are performed (e.g., the wired/wireless operations being performed between the electronic device 102 and 108) (e.g., formation of the air-core transformer is initiated) (e.g., formation of the air core transformer is performed) (e.g., the air-core transformer is formed) in response to a distance between the electronic device 102 and the electronic device 108 being less than a threshold distance (e.g., a maximum distance) (e.g., 4 centimeters, 10 centimeters, 20 centimeters, etc., with a variation of 1 millimeters, 1 centimeter, etc.). In various cases, the electronic device 108 being in a “proximity” of the electronic device 102 includes the electronic device 102 and the electronic device 108 being positioned with the distance between the electronic device 102 and the electronic device 108 being less than the threshold distance.

In those or other examples, the electronic device 102 transmitting the wired control signal to the adapter device 106 to generate the wireless field (e.g., the NFC field) enables the air-core transformer to be formed, in response to the distance between the electronic device 102 (e.g., the adapter device 106) and the electronic device 108 (e.g., the communications connection device 110) being less than the threshold distance.

In various cases, transmitting of a field generating signal (e.g., the wired control signal) includes transmitting (e.g., transmitted via the wired/wireless converting) of a pulse signal (or “pulse”) or a continuous signal. In some examples, for instance with the wired control signal including the pulse, the adapter device 106 is utilized by the electronic device 102 to maintain generation of the wireless field at an ongoing basis (e.g., until another pulse signals, such as a “stop,” signal, is transmitted by the electronic device 102, (e.g., transmitted via the wired/wireless converting). In another example, for instance with the wired control signal including the continuous signal, the adapter device 106 is utilized by the electronic device 102 to maintain generation of the wireless field at an ongoing basis (e.g., until the transmitting of the continuous signal stops).

In some instances, for example with the wireless field being an NFC field, such as an alternating magnetic field being utilized as a “primary coupling factor” between the electronic device 102 (e., the adapter device 106) and the electronic device 108 (e.g., the communications connection device 110), power being radiated (e.g., radiated from the wireless field) (e.g., radiated, externally) in a form of radio waves (e.g., electromagnetic waves, also involving an oscillating electric field), is maintained below a threshold power. By maintaining the power below the threshold power, for instance with examples in which the wireless field includes the NFC field being generated in response to the wired control signal, such as the USB control signal, a level of interference between the devices (e.g., the electronic device 102, the electronic device 108, or any combination thereof) and other devices (e.g., other NFC devices, other types of devise, or any combination thereof), such as a level of interference associated with any radio communications at a same frequency as, or different frequency from, the AC power signal (e.g., the different frequency including another frequency that has a value that is greater than, or less than, a frequency of the AC signal transmitted by the electronic device 102, with a difference between the value of the other frequency and a value of a frequency of the AC signal transmitted by the electronic device 102 being less than a threshold difference), is maintained below a threshold interference level. Because an importance of providing reliable treatment to patients is relatively high in certain scenarios, such as in emergency scenarios, utilizing USB/NFC operations enable electronical interference between electronic devices to be minimized (e.g., such as for instances in which the electronic device 102, the electronic device 108, or any combination thereof, are medical devices), thereby increasing reliability of treatment provided via the electronic devices.

In some cases, the electronic device 108 does not include a power supply. For instance, with examples in which the electronic device 108 does not include the power supply, the electronic device 108 receives power from the wireless field generated by the electronic device 108 (e.g., the electronic devices 108 utilizes the communications connection device 110 to receive power, from the electronic device 102, such as from the communications connection device 104, via the wired/wireless operations enabled via the adapter device 106).

In those or other examples, such as with the electronic device 108 not including the power supply, the electronic device 108 receives power from a magnetic field (e.g., a magnetic field as part of the wireless field) generated by the electronic device 108. For instance, with examples in which the electronic device 108 does not include the power supply, the electronic device 108 communicates with the electronic device 102 (e.g., the electronic devices 102 and 108 utilize the communications connection devices 104 and 110 respectively, to communicate, via the wired/wireless operations enabled via the adapter device 106) via a first mode of wireless communication included in various wireless communication modes (e.g., various modes utilized to exchange wireless communications, transmit/receive wireless signals, or any combination thereof, using the wireless protocols).

In various cases, such as for the examples in which the electronic device 108 without the power supply utilizes the first mode of wireless communication, the wired/wireless data is exchanged between the electronic device 102 and the electronic device 108 by the electronic device 108 utilizing (e.g., modulating) the wireless field (e.g., the wired control signal initiated wireless field) (e.g., the USB control signal initiated NFC field) for communications (e.g., the electronic device 108 “acts” as a “transponder,” such as by receiving signals, and, upon receiving, signals, emits different signals in response). In those cases, any wired/wireless related operations (e.g., the wired/wireless operations) (e.g., the USB/NFC operations), such as the converting, the detecting, the pairing, the communicating, any other wired/wireless related operations, or any combination thereof, are performed utilizing the wireless field for communications (e.g., the wired/wireless related operations are performed via wireless field modulating, which is utilized by the electronic device 102, the communications connection device 104, the adapter device 106, the electronic device 108, the communications connection device 110, to generate wired/wireless data, which is exchanged by communications with the electronic device 102 via the wired/wireless converting).

Alternatively, the electronic device 108 includes a power supply. For instance, with examples in which the electronic device 108 includes the power supply, the electronic device 102 and the electronic device 108 communicate (e.g., the electronic devices 102 and 108 utilize the communications connection devices 104 and 110 respectively, to communicate, via the wired/wireless operations enabled via the adapter device 106) via a second mode of wireless communication from among various modes of wireless communications.

In various cases, such as for the examples in which the electronic device 108 including the power supply utilizes the second mode of wireless communication, the electronic device 102 and the electronic device 108 communicate to exchange the wired/wireless data by alternately generating their own fields (or “alternatively generated fields”) (e.g., wireless fields (e.g., NFC fields). In those cases, for instance, a device (e.g., the electronic device 102 or the electronic device 108) transmits data, and the other device stops transmitting in order to receive the transmitted data. In those examples, any wired/wireless related operations (e.g., the wired/wireless operations) (e.g., the USB/NFC operations), such as the converting, the detecting, the pairing, the communicating, any other wired/wireless related operations, or any combination thereof, are performed utilizing the alternatively generated fields (e.g., the wired/wireless related operations are performed via the alternatively generated fields, which are utilized by the electronic device 102, the communications connection device 104, the adapter device 106, the electronic device 108, the communications connection device 110, to generate wired/wireless data, which is exchanged by communications with the electronic device 102 via the wired/wireless converting).

In various embodiments, the electronic device 102 and the electronic device 108 perform the wired/wireless operations (e.g., the electronic devices 102 and 108 utilize the communications connection devices 104 and 110 respectively, to communicate, via the wired/wireless operations enabled via the adapter device 106) via the first mode of wireless communication, the second mode of wireless communication, any other wireless communication modes from among the various modes of wireless communications, or any combination thereof. For example, the electronic device 102 and the electronic device 108 exchange the wired/wireless communications via any types of NFC protocol related communication modes, any other types of other wireless communication modes associated with any other wireless protocol, or any combination thereof.

In some examples, the wired/wireless operations include operations that are in the wireless device converting operations and that are performed by the adapter device 102, which utilizes the adapter device 106 (e.g., the wireless device converting assisting operations performed by the adapter device 106). In various implementations, the wireless device converting operations performed by the electronic device 102, which utilizes the adapter device 106, include converting of wired signals to wireless signals, converting of wired protocols to wireless protocols, converting of wireless signals to wired signals, converting of wireless protocols to wired protocols, and any combination thereof.

In some examples, the converting includes utilizing corresponding electronic devices (e.g., electronic sub-devices) (e.g., circuits, processors, memory, etc.) of the electronic device 102 (e.g., a circuit that is included in the electronic device 102 and that electrically connects any portions (e.g., devices, sub-devices, etc.) of the electronic device 102), the communications connection device 104 (e.g., a circuit that is included in the communications connection device 104 and that electrically connects any portions (e.g., devices, sub-devices, etc.) of the communications connection device 104), the adapter device 106 (e.g., a circuit that is included in the adapter device 106 and that electrically connects any portions (e.g., devices, sub-devices, etc.) of the adapter device 106), and any combination thereof, to convert wired signals to wireless signals, convert wired protocols to wireless protocols, convert wireless signals to wired signals, convert wireless protocols to wired protocols, and any combination thereof. In those or other examples, the converting includes utilizing antennas (e.g., an antenna of the adapter device 106) to convert wired signals to wireless signals, convert wireless signals to wired signals, and any combination thereof.

In some examples, the converting includes utilizing the corresponding circuits of the electronic device 102, the communications connection device 104, the adapter device 106, and any combination thereof, and utilizing the antennas (e.g., an antenna of the adapter device 106) to convert wired signals transmitted by the electronic device 102 to wireless signals transmitted by the adapter device 106 (e.g., and to the communications connection device 110). In some examples, the converting includes utilizing the corresponding circuits of the electronic device 102, the communications connection device 104, the adapter device 106, and any combination thereof, and utilizing antennas (e.g., an antenna of the adapter device 106) to convert wireless signals received by adapter device 106 (e.g., and from the communications connection device 110) to wired signals received by the electronic device 102.

In some examples, the wired/wireless operations include operations that are in the wireless device converting operations and that are performed by the electronic device 108, which utilizes the communications connection device 110. In various implementations, the wireless device converting operations performed by the electronic device 108, which utilizes the communications connection device 110, include converting of wired signals to wireless signals, converting of wired protocols to wireless protocols, converting of wireless signals to wired signals, converting of wireless protocols to wired protocols, and any combination thereof.

In some examples, the converting includes utilizing corresponding electronic devices (e.g., electronic sub-devices) (e.g., circuits, processors, memory, etc.) of the electronic device 108 (e.g., a circuit that is included in the electronic device 108 and that electrically connects any portions (e.g., devices, sub-devices, etc.) of the communications electronic device 108), the communications connection device 110 (e.g., a circuit that is included in the communications connection device 110 and that electrically connects any portions (e.g., devices, sub-devices, etc.) of the communications connection device 110), and any combination thereof, and utilizing the antennas (e.g., an antenna in the communications connection device 110), to convert wireless signals received by communications connection device 110 (e.g., and from the adapter device 106) to wired signals received by the electronic device 108. In some examples, the converting includes utilizing corresponding circuits of the electronic device 108, the communications connection device 110, and any combination thereof, and utilizing the antennas (e.g., the communications connection device 110), to convert wired signals transmitted the electronic device 102 to wireless signals transmitted by the communications connection device 110 (e.g., and to the adapter device 106).

In some implementations, wired/wireless conversions (e.g., USB/NFC conversions) include conversions between the wired and wireless signals (or “wired/wireless converting”) (e.g., conversions between the USB and NFC signals (or “USB/NFC converting”)), conversions between the wired and wireless protocols (e.g., USB and NFC protocols), or any combination thereof. For instance, the USB/NFC converting is performed via various operations (e.g., USB and NFC signals conversion operations, USB and NFC protocols conversion operations, or any combination thereof).

In some examples, USB/NFC conversion operations are performed by the electronic device 102, the adapter device 106, or any combination thereof. In those or other examples, the USB/NFC conversions include USB-NFC conversions (e.g., conversions of signals in compliance with the USB protocol to signals in compliance with the NFC protocol) (e.g., conversions from the USB to NFC protocols), NFC-USB conversions (e.g., conversions of signals in compliance with the NFC protocol to signals in compliance with the USB protocol) (e.g., conversions from the NFC to USB protocols), or any combination thereof.

In some examples, for instance with the communications connection device 110 including, or being included in, a USB device, USB/NFC conversion operations are performed by the electronic device 108, the USB device, or any combination thereof. In those or other examples, the USB/NFC conversion operations include USB-NFC conversions (e.g., conversions of signals in compliance with the USB protocol to signals in compliance with the NFC protocol) (e.g., conversions from the USB to NFC protocols), NFC-USB conversions (e.g., conversions of signals in compliance with the NFC protocol to signals in compliance with the USB protocol) (e.g., conversions from the NFC to USB protocols), or any combination thereof.

Although, in some instances, the communications connection device 110 includes, or is included in, the USB device, as discussed above in the current disclosure, it is not limited as such. In some examples, for instance with the communications connection device 110 not including, or being included in, any USB device, no USB/NFC conversion is performed by the electronic device 108, the communications connection device 110, and any combination thereof, and the antenna in the communications connection device 110.

In some examples, the wired/wireless operations include the wireless device detecting operations being performed, by the electronic device 102, which utilizes the adapter device 106 (e.g., the wireless device detecting assisting operations performed by the adapter device 106). In various implementations, the wireless device detecting operations include detecting (e.g., via the converting) of another wireless device (e.g., the electronic device 108).

In various implementations, the wireless detecting being performed by the electronic device 102 (e.g., the electronic device 102 utilizing the adapter device 106) includes detecting (e.g., wired/wireless detecting) (e.g., wired protocol and wireless protocol enabled detecting) (e.g., USB protocol and NFC protocol enabled detecting) (or “USB/NFC enabled detecting”) that is performed utilizing the wired protocol and the wireless protocol. For example, and for purposes of illustration, the detecting by the electronic device 102 of the electronic device 108 is represented in FIG. 1, on the right side, by the dotted-line “star” around the electronic device 108.

In some examples, the electronic device 102 utilizes (e.g., identifies, determines, stores, generates, modifies data) data (e.g., stores the data in a storage device (e.g., memory, a hard drive, or any number of storage devices of any types) of the electronic device 102) that includes wireless detection data (e.g., data representing a wireless detection status) (e.g., data stored in the storage device of the electronic device 102) to indicate whether the wireless device (e.g., the electronic device 108) is detected. In those or other examples, the wired/wireless data includes the wireless detection data being managed (e.g., identified, determined, generated, modified, etc.) in response to the wired/wireless data indicating the electronic device 108 (e.g., the communications connection device 110) is detected (e.g., via any of the various wired/wireless communication modes, or any combination thereof).

In those or other examples, the wireless detection data associated with the electronic device 108 being detected includes a value of “detected,” and the wireless detection data associated with the electronic device 108 being detected includes a value of “undetected” (e.g., an initial value of the wireless detection data associated with the wireless detection status is “undetected”). In some examples, the wireless detection data includes a flag (or “wireless detection flag”) (or “detection flag”) utilized by the electronic device 102 to indicate whether the wireless device is detected. For instance, the detection flag initially includes a value of “0” prior to any wireless detection; and the electronic device 102 sets the detection flag (e.g., modifies the flag to have a value of “1”) in response to the electronic device 108 being detected.

In various implementations, the pairing operations include the electronic device 102 pairing with the other wireless device (e.g., the electronic device 108). In some examples, the pairing operations are performed in response to the detecting of the electronic device 108 being performed (e.g., in response to successful completion of the detecting, which indicates a presence of the electronic device 108). In those or other examples, the pairing operations are performed in response to the detection status data indicating “detected.” In those or other examples, the pairing operations are performed in response to the detection flag data being set.

For instance, the pairing operations are utilized to pair the electronic device 102 and the electronic device 108. In some examples, the pairing is initiated in response to a signal (e.g., a signal transmitted via the wireless protocol) (e.g., a wireless protocol signal) (e.g., a short-range wireless communication protocol signal) (e.g., a pairing request) transmitted by the electronic device 108 and to the electronic device 102. In those or other examples, the pairing is initiated in response to the wireless protocol signal) being transmitted by the electronic device 108 and to the electronic device 102, in response to the distance (e.g., the distance between the electronic device 108 and the electronic device 102) being less than or equal to the threshold distance. In those or other examples, the pairing is initiated in response to the electronic device 102 converting, via the adapter device 106, the wireless protocol signal to another signal (e.g., a signal transmitted via the wired protocol) (e.g., a wired protocol signal). For example, the pairing is performed in response to the wired protocol signal being received by the electronic device 102 and from the adapter device 106.

In some examples, the electronic device 102 utilizes the adapter device 106 to pair the electronic device 102 with the electronic device 108. In those or other examples, pairing (e.g., pairing performed utilizing the pairing operations) is performed between the electronic device 102 and the electronic device 108, by performing the pairing operations. In those or other examples, completion of the pairing is achieved in response to completion of the pairing operations.

In various implementations, the pairing includes pairing request values. For example, any of the pairing request values includes an identifier, an authentication flag, or a type of information (e.g., a value identifying the information type). In some cases, the identifier, the authentication flag, the type of information, any other type of pairing request value, or any combination thereof, is transmitted to the electronic device 102 and by a pairing device (e.g., the electronic device 108).

In some examples, the electronic device 102 compares individual ones of the pairing request values to corresponding pairing characteristics (e.g., corresponding predefined pairing values, corresponding threshold pairing values, etc.). In those or other examples, the electronic device 102 identifies whether the pairing is successful in response to the corresponding pairing characteristics being satisfied. The electronic device 102, for example, utilizes the pairing request values to perform the pairing in response to the pairing request values satisfying the corresponding pairing characteristics. For example, the pairing is performed in response to the identifier matching an identifier characteristic (e.g., a characteristic indicating an identifier associated with the device (e.g., the electronic device 108) enabled, activated, etc., to be paired), the authentication flag having a value matching a flag characteristic (e.g., a characteristic indicating a flag indicating that pairing is allowed, enabled, etc. for the device (e.g., the electronic device 108)), the type of information to be communicated for the device (e.g., the electronic device 108) matching and/or satisfying an information type characteristic (e.g., a characteristic indicating an allowed information type)), or any combination thereof.

In some cases, the electronic device 102 performs the pairing operations (e.g., the pairing is performed between the electronic device 102 and the electronic device 108) in response to a distance between the adapter device 106 and the electronic device 108 being less than a threshold distance (e.g., a maximum distance) (e.g., 4-10 centimeters) (e.g., 4 centimeters, 10 centimeters, 20 centimeters, etc., with a variation of 1 millimeters, 1 centimeter, 2 centimeters, etc.). In various implementations, the pairing includes a tap-to-pair pairing process.

In some instances, the distance between the adapter device 106 and the electronic device 108 utilized to initiate (e.g., begin) the pairing is the same as the distance utilized for the performing of the wireless device detecting. Alternatively, the distance between the adapter device 106 and the electronic device 108 utilized to initiate (e.g., begin) the pairing is different from the distance utilized for the performing of the wireless device detecting.

In some implementations, pairing data, a pairing flag, etc., is utilized in a similar way as the detection data, the detection flag, etc., respectfully. For example, the pairing data includes a value (e.g., a value of “paired” or “unpaired”), the pairing flag includes a value (e.g., a value of “0” or “1”), or any combination thereof, in response to whether the pairing is successfully completed. For example, the pairing flag (e.g., a pairing request flag) is set in response to the electronic device 108 being authenticated (e.g., authentication via the identifier matching a stored identifier (e.g., the identifier characteristic) being utilized as authentication) via the pairing.

In various implementations, the communicating operations include the electronic device 102 communicating with the other wireless device (e.g., the electronic device 108). In some examples, the communicating operations are performed in response to the electronic device detecting being performed (e.g., in response to successful completion of the detecting, which indicates a presence of the electronic device 108), and, possibly, in response to the pairing being performed, and, possibly, in response to any other wired/wireless operations being performed. In those or other examples, the communicating operations are performed, possibly, in response to the detection status data indicating “detected,” the detection flag data being set, the pairing status data indicating “paired,” the pairing flag data being set, or any combination thereof.

In various examples, the communicating is performed utilizing security keys. In some cases, the communicating (e.g., communicating of any data transmitted by the electronic device 108, any data transmitted by the electronic device 102, or any combination thereof) includes the electronic device 108 transmitting a security key to the electronic device 102, via the adapter device 106, and the electronic device 102 receiving the wired protocol signal further comprises receiving, via the port, the wired protocol signal comprising a security key provided by the electronic device 108.

In various cases, the communicating is performed in response to a successful comparison being performed by the electronic device 102 of the security key (e.g., a received security key). For example, the electronic device 102 compares the received security key to a stored security (e.g., a predetermined security key, a previously generated security key, a previously received security key, or any combination thereof).

In some cases, the communicating is performed in response to establishing a communication channel (e.g., a secure communication channel). For example, the electronic device 102 compares the received security key to the stored security and establishes the communication channel (e.g., a communication channel between the electronic device 102 and the electronic device 108, via the adapter device 106), in response to a satisfactory result of the comparison. In various cases, the communication channel is established, in response to verifying the security is received security key includes a valid security key, in response to the satisfactory result of the comparison.

For instance, the communicating operations are utilized to exchange wired/wireless communications (e.g., wired/wireless signals utilizing the wired protocol and the wireless protocol) (e.g., USB/NFC signals between the electronic device 102 and the electronic device 108. In some examples, the electronic device 102 utilizes the adapter device 106 to exchange communications with the electronic device 108. In those or other examples, communicating (e.g., communicating performed utilizing the communicating operations) is performed between the electronic device 102 and the electronic device 108, by performing the communicating operations.

In some cases, the electronic device 102 performs the communicating operations (e.g., the communicating is performed between the electronic device 102 and the electronic device 108) in response to a distance between the adapter device 106 and the electronic device 108 being less than a threshold distance (e.g., a maximum distance) (e.g., 4 centimeters, 10 centimeters, 20 centimeters, etc., with a variation of 1 millimeters, 1 centimeter, etc.). In some instances, the distance between the adapter device 106 and the electronic device 108 utilized to initiate (e.g., begin), perform, etc., the communicating is the same as the distance utilized for the performing of the wireless device detecting. Alternatively, the distance between the adapter device 106 and the electronic device 108 utilized to initiate (e.g., begin), perform, etc., or any combination thereof, the communicating the same as, or different from, the distance utilized for the performing of the wireless device detecting.

In some instances, the distance between the adapter device 106 and the electronic device 108 utilized to initiate (e.g., begin), perform, etc., the communicating is the same as the distance utilized for the performing of the wireless device pairing. Alternatively, the distance between the adapter device 106 and the electronic device 108 utilized to initiate (e.g., begin), perform, etc., or any combination thereof, the communicating the same as, or different from, the distance utilized for the performing of the wireless device pairing.

In some implementations, communicating data, a communicating flag, etc., is utilized in a similar way as the communicating data, the communicating flag, etc., respectfully. For example, the communicating data includes a value (e.g., a value of “communicated” or “not yet communicated”), the communicating flag includes a value (e.g., a value of “0” or “1”), or any combination thereof, in response to whether the communicating is successfully completed.

In various cases, the communicating data includes data that is transmitted by the electronic device 102, via the adapter device 106, and to the electronic device 108, data that is transmitted by the electronic device 108 and to the electronic device 102, via the adapter device, 106, or any combination thereof. Data (e.g., data stored in the electronic device 102) that is communicated, via the wired/wireless communications, in some examples, via transmissions to the electronic device 108, is stored in the electronic device 108, such as, for instance, with data being transmitted by the electronic device 102, via the adapter device 106, and to the electronic device 108. Data (e.g., data stored in the electronic device 108) that is communicated, via the wired/wireless communications, in some examples, via transmissions to the electronic device 102, is stored in the electronic device 102, such as, for instance, with data being transmitted by the electronic device 108, and to the electronic device 102, via the adapter device 106.

In various cases, the wired/wireless operations are utilized for various purposes. For example, the wired/wireless operations are utilized as part of, to support, to enable, etc., an ECG functionality (e.g., an ECG mode), a blood oxygenation functionality (e.g., a blood oxygenation mode), a capnography functionality (e.g., a capnography functionality mode), an invasive blood pressure (IBP) functionality (e.g., IBP mode), a non-invasive blood pressure functionality (e.g., a non-invasive blood pressure mode), a mechanical cardio pulmonary respiratory (CPR) functionality (e.g., a CPR mode), a logistical functionality (e.g., a logistical mode), a location services functionality (e.g., a location mode), a CPR feedback functionality (e.g., a CPR feedback mode), an ultrasound functionality (e.g., a ultrasound mode), a video laryngoscope functionality (e.g., a video laryngoscope mode), a payment system functionality (e.g., a payment system mode) (or “payment mode”), an inventory system functionality (e.g., an inventory system mode) (or “inventory mode”), a record keeping system functionality (e.g., a record keeping system mode) (or “record keeping mode”), a smart phone functionality (e.g., a smart phone (e.g., mobile device) (e.g., cellular device) mode), an employee badge functionality (e.g., an employee badge mode), or an RF asset tracking tag functionality (e.g., an RF asset tracking tag mode), any other medical functionality, any other non-medical functionality, or any combination thereof.

In some examples, the wired/wireless operations are utilized as part of, to support, to enable, etc., ECG sensors, blood oxygenation sensors, capnography sensors, invasive blood pressure (IBP) sensors, non-invasive blood pressure sensors, mechanical CPR sensors, logistical sensors, location sensors, CPR feedback sensors, ultrasound sensors, video laryngoscope sensors, payment system sensors, smart phone sensors, employee badge sensors, RF asset tracking tag sensors, any other medical sensors, any other non-medical sensors, or any combination thereof. In those or other examples, the wired/wireless operations are utilized as part of, to support, to enable, etc., ECG devices, blood oxygenation devices, capnography devices, invasive blood pressure (IBP) devices, non-invasive blood pressure devices, mechanical CPR devices, logistical devices, location devices, CPR feedback devices, ultrasound devices, video laryngoscope devices, payment system devices, inventory devices, smart phone devices, employee badge devices, RF asset tracking tag devices, any other medical devices, any other non-medical devices, or any combination thereof.

While the sensors are different from the devices associated with the wired/wireless operations, as discussed above in the current disclosure, it is not limited as such. In some examples, any of the sensors (e.g., any of the sensors associated with the wired/wireless operations) are part of, combined with, integrated together with, etc., in any way, any of the devices (e.g., any of the devices associated with the wired/wireless operations).

In some cases, any of various operations (e.g., any of the adapter device related operations, any of the wired/wireless operations, any other operations related to any device, such as the electronic device 102, the communications connection device 104, and/or the adapter device 106, a wireless field associated with the electronic device 108, the communications connection device 110, or any combination thereof) is performed in response to a user selection, or combination of user selections, received via user input to the electronic device 102 (e.g., a user interface (UI), a graphical user interface (GUI), an input device, etc., or any combination thereof, of the electronic device 102). In some cases, the user selections are received via touchscreens, button, keyboards, mice, any other device of the electronic device 102, or any combination thereof.

In various examples, the user selections are received in response to a notification or a combination of notifications, output via the electronic device 102 (e.g., a display, a touchscreen, the UI, the GUI, etc., or any combination thereof. In some cases, the notifications are output audibly, visually, haptically, etc., or any combination thereof. In various instances, the notifications are output at beginnings of any of the operations to receive user input to proceed, endings of any of the operations to receive user input as confirmation, any intervening portions (e.g., portions between the beginnings and the endings of the operations) to request confirmation to continue or acknowledgement of errors, etc., or any combination thereof.

For instance, the user selections include an adapter device configuration selection, an adapter device initialization selection, a setup selection, a driver identity, load, stored, and/or install selection, an adapter device activation selection, a detection selection, a pair selection, a communication selection, or any combination thereof. In some cases, any of the selections are received in response to corresponding notifications (e.g., corresponding prompts) output by the electronic device 102, the notifications requesting the user selections (e.g., confirmation, permission, acknowledgement, etc.) to continue with corresponding operations.

For example, in response to the identified electrical characteristics associated with the adapter device 106, a notification is output by the electronic device 102 requesting a user selection to proceed with activating the adapter device 106. In some instances, the user selection is received via user input as confirmation to proceed with the activating of the adapter device 106, and the activating of the adapter device 106 is performed by the electronic device 102 in response to the user selection. In such instances or other instances, the activating of the adapter device 106 is performed in response to power received from the communication connection device 104.

In another example, in response to the converting, the detecting, the pairing, the activating, etc., a notification is output by the electronic device 102 requesting a user selection to proceed with establishing a communication channel. In some instances, the user selection is received via user input as confirmation to proceed with the establishing of the communication channel, and the communication channel is established by the electronic device 102 in response to the user selection.

In another example, in response to the converting, the detecting, the pairing is performed utilizing communications (e.g., first communications, which include wireless communications received from the electronic device 108) being converted by the electronic device 102, via the adapter device 106, to converted communications (e.g., wired communications) associated with the wired protocol. In some cases, the electronic device 102 outputs a notification requesting a user selection to proceed with communicating data between the electronic device 102 and the electronic device 108.

In some examples, the notification requesting the user selection to proceed with communicating is output in response to a pairing request flag. In those or other examples, the pairing request flag is set in response to a pairing request characteristic (or “pairing characteristic”) being satisfied by a pairing request value. In those or other examples, the notification being output in response to the pairing request flag is utilized to receive a user selection via user input to the electronic device 102. In those or other examples, the notification confirms the electronic device 108 is authenticated, in response to the pairing request flag being set.

In those or other examples, in response to the pairing request flag (e.g., the pairing request flag being set) and the user selection (e.g., the user selection being identified, determined, received, etc., or any combination thereof), the communicating (e.g., exchanging the communications (e.g., second communications) is performed. In various cases, the user selection is received via user input to the input device of the electronic device 102, the user selection identifying the notification confirming the wireless device is authenticated.

In various cases, the electronic device 102 outputs a notification (or “unauthenticated notification”) (e.g., a warning notification) (e.g., a caution notification) in response to individual ones of the pairing request values not matching the other pairing request values (e.g., the predetermined pairing request values). For example, the unauthenticated notification is output (e.g., output such as by the display) to inform a user (e.g., a medical provider) that the electronic device 108 is not authenticated.

In various cases, the electronic device 108 not being authenticated is in response to any of the pairing request values not satisfying the corresponding pairing characteristics, such as for instances in which the electronic device 108 includes a brand, a type, a model, or any combination thereof, that is not associated with any of the pairing request values. For example, the electronic device 108 not being authenticated is in response to the electronic device 102 identifying an absence of certification associated with the electronic device 108.

In some cases, with any of the pairing request values not being satisfied, such as for instance with the unauthenticated notification being output, or for instance with no unauthenticated notification being output, the electronic device 102 prevents, blocks, or any combination thereof, some or all of the wired/wireless operations (e.g., the communicating) for the electronic device 108. For example, the electronic device 102 prevents, blocks, or any combination thereof, performance of some or all of the wired/wireless operations (e.g., the communicating) with respect to the electronic device 108, with or without the unauthenticated notification being output.

In various implementations, the electronic device 102 receives user selections (e.g., an override selection) associated with user input to the electronic device 102, in response to the authentication notification. For example, the electronic device 102 overrides preventing some or all of the wired/wireless operations (e.g., the communicating) for the electronic device 108, in response to the override user selection. Alternatively, the electronic device 102 refrains from processing any override selections, and/or disables any user input processing, in response to any of the pairing request values not being satisfied, the unauthenticated notification being output, or any combination thereof.

In some instances, by utilizing devices (e.g., the electronic device 102), with adapters (e.g., the adapter device 106) capable of being utilized to perform the wired/wireless conversions (e.g., the USB/NFC conversions), communications are exchanged via the USB and NFC protocols in a faster and more secure way than by utilizing other protocols (e.g., a bluetooth protocol). For example, by utilizing the NFC protocol, cross talk that otherwise may occur while utilizing the bluetooth protocol is reduced, prevented, and/or eliminated. In some cases, triage situations with multiple devices that utilize the bluetooth protocol and that unintentionally “try to pair together” due to one of the devices being booted up are reduced, prevented, and/or eliminated by utilizing the adapters that are capable of being utilized to perform the USB/NFC conversions.

In some cases, by utilizing the adapters that are capable of being utilized to perform the wired/wireless conversions (e.g., the USB/NFC conversions), cables that may otherwise require wired connections to the electronic device 102 are able to be avoided and replaced with cables communicating wirelessly via the adapters. By avoiding cables with wired connections, cable management is unnecessary, which increases safety, efficiency, and effectiveness of medical treatment being provide to patients via devices utilizing communications via the adapters that are capable of being utilized to perform the USB/NFC conversions. As a result, numbers of successful medical treatments are increased, numbers of lives being saved are increased, and opportunities for occurrences of problems are decreased.

By utilizing the adapters that are capable of being utilized to perform the wired/wireless conversions, transporting and monitoring of patients being treated utilizing the devices with the adapters are simpler and more streamlined. By utilizing the adapters that are capable of being utilized to perform the wired/wireless conversions, various devices that are not compatible with the NFC protocol are able to communicate via the NFC protocol, in response to the wired/wireless conversions (e.g., the USB/NFC conversions) being performed utilizing the adapters. Cables being paired to the devices with the adapters, for instance, are able to be quickly paired, such as by tap-to-pairing processes, regardless of the devices not being capable of performing the wired/wireless conversions without the adapters, in response to the devices and the adapters being coupled together (e.g., being connected or integrated together).

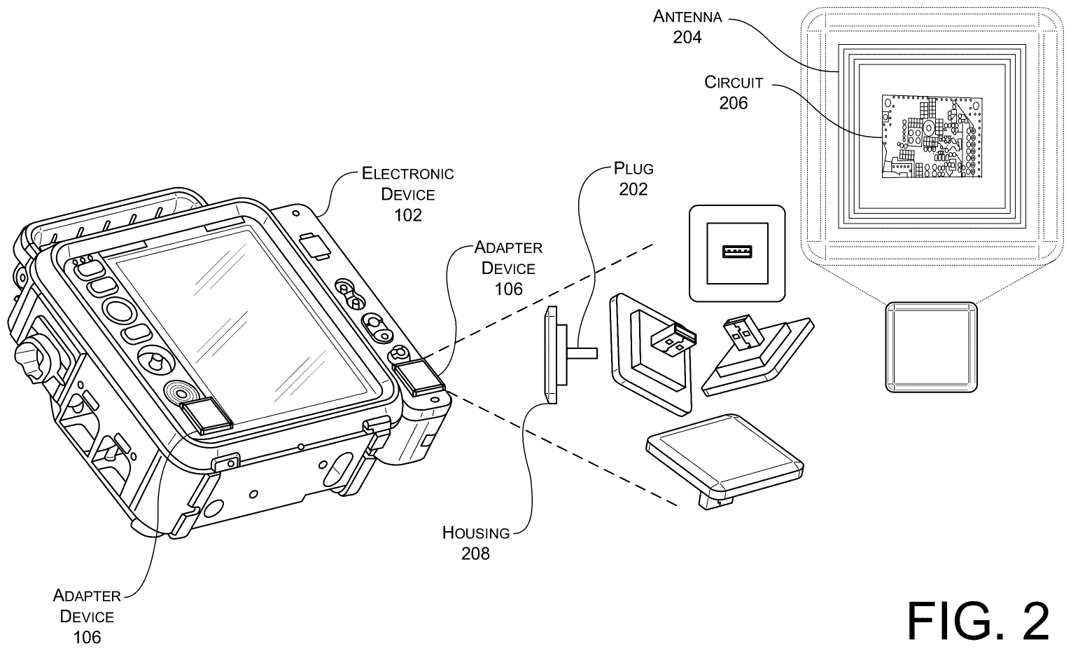

FIG. 2 illustrates an example environment in which a device, including a monitoring device with a universal serial bus (USB) device, is utilized to establish communications utilizing a near field communication (NFC) compatible connector, the USB device being interconnected with the NFC compatible connector.

In various implementations, the electronic device 102 and the adapter device 106, are communicatively coupled via a communications connection device (e.g., the communications connection device 104), as discussed above with reference to FIG. 1. For example, the electronic device 102 includes the monitoring device. In some examples, the communications connection device 104 is compatible with the adapter device 106, which includes a connector. In those or other examples, the electronic device 102 is enabled, via the adapter device 106, to be interconnected with another device (e.g., the electronic device 108, which includes the communications connection device 110, as discussed above with reference to FIG. 1).

In some cases, adapter device includes a plug 202, an antenna 204, and a circuit 206. For example, the plug 202 includes a plug (or “wired protocol plug”) associated with a wired protocol (e.g., a USB protocol). In some cases, the antenna 204 includes an antenna (or “wireless protocol antenna”) associated with a wireless protocol (e.g., an NFC protocol). In some cases, the circuit 206 is associated with the wired protocol (e.g., the USB protocol), the wireless protocol (e.g., the NFC protocol), any other wired protocol, any other wireless protocol, or any combination thereof.

In some instances, adapter device dimensions, adapter device orientations, or any combination thereof, include the plug 202 (e.g., an axis of a long edge of the plug 202) being aligned with a plane that is perpendicular to a plane associated with the antenna 204 (e.g., an axis of a long edge of the antenna 204), the circuit 206 (e.g., an axis of a long edge of the circuit 206), or any combination thereof. For example, the adapter device dimensions, the adapter device orientations, or any combination thereof, include the plug 202 being aligned with a z-axis with respect to an x-y plane, with which the antenna 204 and the circuit 206 are aligned. In some cases, the adapter device dimensions, the adapter device orientations, or any combination thereof, include the antenna 204 and the circuit 206 being aligned in a same plane, associated with a point on the z-axis. For instance, the antenna 204 encircles, surrounds, etc., the circuit 206.

In some cases, the adapter device 206 includes a cover, a case, an external surface, etc., or any combination thereof. For example, the adapter device 206 includes a case with an external edge that is square shaped from a top-view or a bottom-view. In some examples, the adapter device 206 is a mobile, portable, powered via an internal power source (e.g., a battery, a capacitor, etc.).

In some examples, the adapter device 206 includes a portion (e.g., a first portion) that is flat, and adjacent (e.g., adjacent along a vertical axis with respect to a plane that is aligned with a longest edge of the first portion) to a portion (e.g., a second portion) that is flat. In those or other examples, the plug 202 extends from the first portion, the second portion, or any combination thereof. For example, the second portion is smaller in width, length, or any combination thereof, than the first portion. In those or other examples, the first portion and the second portion are square-shaped and aligned with planes that are parallel to one another and that are perpendicular to an axis along with a longest side of the plug 202 is aligned.

In various cases, the adapter device 206 is separate, remote, different, external, independent, etc., from the medical device. In some examples, the circuit 206 is separate, remote, different, external, independent, etc., from a circuit, or any circuit, of the electronic device 102. In various examples, the antenna 204 is separate, remote, different, external, independent, etc., from an antenna, or any antenna, of the electronic device 102.

While various dimensions and orientations associated with the adapter device 106 include the adapter device dimensions, the adapter device orientations, or any combination thereof, as discussed above in the current disclosure, it is not limited as such. In some examples, the adapter device dimensions, the adapter device orientations, or any combination thereof, associated with the adapter device 106 include any other adapter device dimensions, any other adapter device orientations, or any combination thereof. In various cases, the other adapter device dimensions, the other adapter device orientations, or any combination thereof, are associated with, compatible with, suitable for, compliant with requirements of, etc., or any combination thereof, any protocol (e.g., any wired protocol, any wireless protocol, etc., or any combination thereof) of the adapter device 106. For example, any number of antennas are positioned adjacent, above, below around, within, etc., any number of circuits associated with the adapter device 106.

In various examples, the adapter device dimensions, the adapter device orientations, or any combination thereof, include the adapter device 206 being any other shape, any other size, any other dimension, any other orientation, or any combination thereof. In some examples, the adapter device 206 includes a power cord.

While the electronic device 102 and a single device, including the electronic device 108, are able to be communicatively connected, as discussed above with respect to FIG. 1 in the current disclosure, it is not limited as such. In some examples, the electronic device 102 is able to be communicatively connected to any number of electronic devices (e.g., multiple electronic devices, a group of electronic devices, a combination of electronic devices, etc.). For instance, with some examples in which the electronic device 102 is being communicatively coupled to individual ones of a group of electronic devices, communicative coupling between the electronic device 102.

In various examples, the communicative coupling of the electronic devices in the group is performed in a similar way as for the communicative coupling for the electronic device 108, as discussed above with reference to FIG. 1. For example, communicative coupling is performed for individual electronic devices in the group is performed consecutively, sequentially, etc. In some cases, any number of operations of the wired/wireless operations associated with any electronic devices being communicatively coupled overlap, with respect to any point in time, with any number of other operations of the wired/wireless operations associated with any other electronic devices being communicatively coupled. In some examples, communicative coupling is performed simultaneously (e.g., such as when separate electronic devices are separately positioned at corresponding distance from corresponding adapter devices, the distances being less than a threshold distance (e.g., a maximum distance)), etc., or in any other way, for individual electronic devices in the group.

In some cases, a bundle of electronic devices is communicatively coupled to the electronic device 102. For example, any of the electronic devices in the bundle includes a sensor. In some cases, any number of the sensors (e.g., some of the sensors or all of the sensors) are similar to one another, or identical to one another, such as for instances in which the sensors are electrocardiogram (ECG or EKG) sensors.

In some examples, the bundle includes a communications connective device and is communicatively coupled in a similar way as for the electronic device 108, as discussed above with reference to FIG. 1. In those or other examples, an electronic device (e.g., the electronic device 108) includes a sensor bundle that includes electrodes utilized to capture data representing electrical signals indicative of an electrical activity of a heart of an individual (e.g., a patient).

In various cases, establishing the communicative connection, such as by performing any of the wired/wireless operations, as discussed above with reference to FIG. 1, by utilizing the adapter device 106, which includes a transceiver (e.g., a transceiver including the antenna 204) (e.g., a first short-range wireless communication transceiver) (e.g., a first NFC transceiver). For instance, establishing the communicative connection includes the adapter device 106 (e.g., the first short-range wireless communication transceiver) being utilized to perform an identification for (e.g., identify) a communications connection device (e.g., a transceiver) (e.g., a second short-range wireless communication transceiver) (e.g., a second NFC transceiver) associated with a housing that includes the sensor bundle.

In some examples, the communicative connection is established, via the communications connection device 104 and the adapter 106 (e.g., the connector), by establishing a communication channel. In those or other examples, the communication channel is established using a sensor of the sensor bundle.

In some cases, the sensor of the sensor bundle includes a transceiver (e.g., a third short-range wireless communication transceiver) (e.g., a third NFC transceiver). In various examples, the communication channel between the electronic device 102 and the sensor of the sensor bundle is established in response to the third short-range wireless communication transceiver of the sensor bundle being identified as being within a distance of the second short-range wireless communication transceiver as the sensor is being pulled out of the housing, in response to the distance between the second short-range wireless communication transceiver and the third second short-range wireless communication transceiver being less than a threshold distance.

In various cases, the communication channel between the electronic device 102 and the sensor of the sensor bundle using a communicative connection between the second short-range wireless communication transceiver and the third short-range wireless communication transceiver, and a communicative connection between the first short-range wireless communication transceiver and the third short-range wireless communication transceiver. In some examples, the communicative connection between the first short-range wireless communication transceiver and the third short-range wireless communication transceiver is established in response to the communicative connection between the first short-range wireless communication transceiver and the second short-range wireless communication transceiver, and the communicative connection between the second short-range wireless communication transceiver and the third short-range wireless communication transceiver.

In some examples, the bundle includes a power supply (e.g., a battery, a capacitor, etc.). In those or other examples, the bundle establishes the communicative connection between the second short-range wireless communication transceiver and the third short-range wireless communication transceiver subsequent to the bundle being positioned with the distance from the electronic device 102 for establishing the communicative connection between the first short-range wireless communication transceiver and the second short-range wireless communication transceiver. Alternatively, the bundle establishes the communicative connection between the second short-range wireless communication transceiver and the third short-range wireless communication transceiver prior to the bundle being positioned with the distance from the electronic device 102 for establishing the communicative connection between the first short-range wireless communication transceiver and the second short-range wireless communication transceiver.

In some cases, any number of communication channels between any number of sensors in the bundle are established. For instance, individual communication channels between corresponding sensors in the bundle are established as the sensors are removed from the housing, in response to any number of short-range wireless communication transceivers (e.g., a single short-range wireless communication transceiver associated with the sensors, or individual short-range wireless communication transceiver associated with corresponding sensors in the bundle) being within a distance of the second short-range wireless communication transceiver as the sensors are being pulled out of the housing, and in response to the distance between the any number of short-range wireless communication transceivers and the third second short-range wireless communication transceiver being less than the threshold distance.

In some cases, the threshold distance associated with the bundle (e.g., the short-range wireless communication transceiver associated with the sensors) and the second short-range wireless communication transceiver is the same as the threshold distance associated with the first short-range wireless communication transceiver and the second short-range wireless communication transceiver. Alternatively, the threshold distance associated with the bundle (e.g., the short-range wireless communication transceiver associated with the sensors) and the second short-range wireless communication transceiver is the different from the threshold distance associated with the first short-range wireless communication transceiver and the second short-range wireless communication transceiver.

By utilizing the bundle, for example, a caregiver is able to hold the bundle, place the bundle, such as the bundle housing, against the electronic device 102 to “activate” the bundle (e.g., establish a communicative connection for the bundle). In some instances, the sensors in the bundle can be “activated” as the caregiver pulls the sensors out of the bundle based on transceivers of the sensors being moved past the transceiver of the bundle housing. The sensors can be communicatively coupled to the electronic device 102 all at the same time, simply, and easily, in response to the bundle being communicatively coupled to the electronic device 102.

By enabling the sensors to be communicatively coupled to the electronic device 102 all together at the same time, for example, a process of communicatively coupling the sensors to the electronic device 102 is streamlined, which greatly decreases potential delays in treating patients, thereby increasing likelihoods of treatment to patients being successful. The sensors, being cordless (e.g., wireless), and the establishing of the reliable connection using the cordless sensors, greatly decreases potential confusion with respect to existing systems that use sensors needing to be physically connected to electronic device via cords.

In various examples, the adapter device 106 is external, and remote with respect to, the electronic device 102. For instance, the adapter device 106 includes a housing 208. In some examples, the housing 208 includes a case, a cover, solid/firm surfaces, pliable surfaces, etc., or any combination thereof. In various implementations, the structure (e.g., the case) of the housing 208 is utilized to provide physical support for the plug 202.

In some examples, the adapter device 106 is integrated within, and internal with respect to, the electronic device 102. For instance, the adapter device 106, which includes a transceiver (e.g., the antenna 204), a circuit (e.g., the circuit 206), or any combination thereof, is included within a housing of the electronic device 102. In some cases, the adapter device 106, being internal to (e.g., integrated within) the electronic device 102, includes a circuit (e.g., a subcircuit of the circuit 206), an antenna, etc., or any combination thereof, which are connected to the USB transceiver, a circuit associated with the USB transceiver, a circuit of the electronic device 102, or any combination thereof.

While the adapter device 106 is coupled (e.g., connected) (e.g., directly connected) to the electronic device 102, as discussed above in the current disclosure, it is not limited as such. In some examples, the adapter device 106 is coupled (e.g., communicatively connected) (e.g., physically connected, electrically connected, etc., or any combination thereof) (e.g., directly coupled) to the electronic device 102 via one or more other devices (or “intervening device(s)”). For instance, the other device(s) can include one or more other devices of various types that are compatible with one or more protocols (e.g., a same protocol with which the adapter device 106 and/or the electronic device 102 is compatible, a different protocol from the protocol with which the adapter device 106 and/or the electronic device 102 is compatible, or any combination thereof).

The other devices, in some examples, utilized to couple the electronic device 102 and the adapter device 106 together include a dongle, an extender, a cable, any other coupling device of any other type, or any combination thereof. In various instances, any of one or more conversions between the electronic device 102 and the intervening device(s), and/or any of one or more conversions between the intervening device(s) and the adapter device 106, are performed in similar ways as the conversion(s) between the electronic device 102 and the adapter device 106 as discussed throughout the disclosure; and the electronic device 102, the intervening device(s), and the adapter device 106 are utilized in a similar way as the electronic device 102 and the adapter device 106 for purposes of implementing any of the techniques as discussed herein.

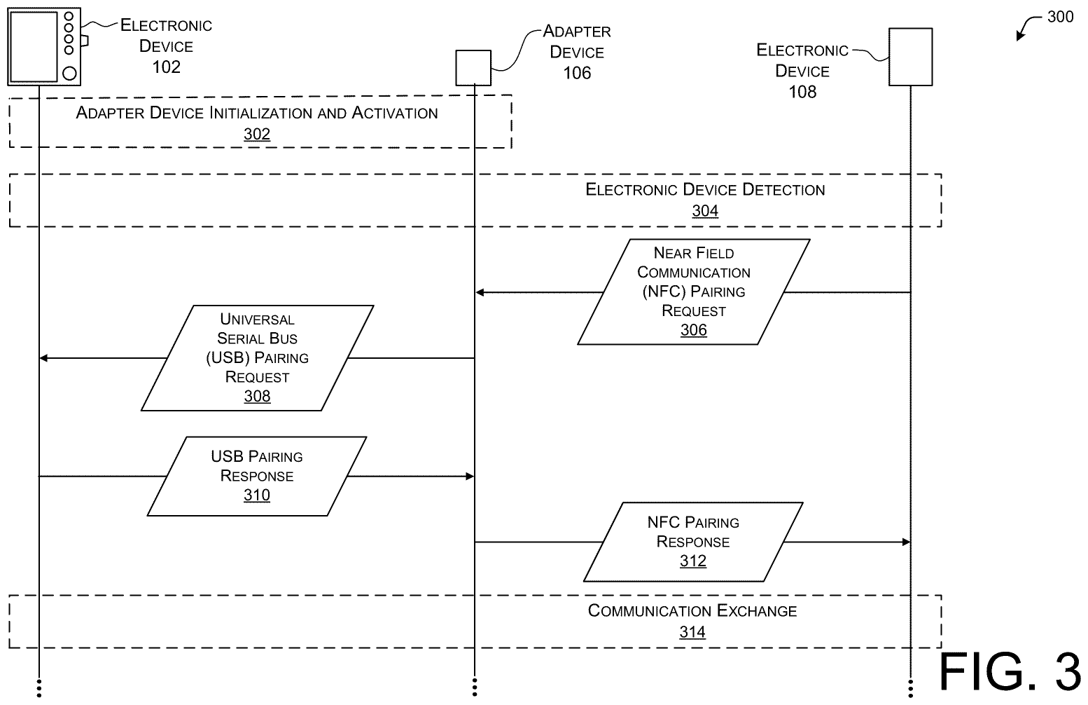

FIG. 3 illustrates an example signal flow 300 for establishing, for a device, including a monitoring device, a communication connection with a medical device, the communication connection enabling communications to be exchanged between the monitoring device and the medical device via a connector that is utilized to convert between various communication protocols.

In some examples, the signal flow 300 includes the adapter device 106 being initialized and activated via an adapter device initialization and activation process (or “adapter device initialization and activation”) 302. In various cases, the adapter device initialization and activation 302 includes the adapter device 106 being initialized and activated in a similar way as discussed above with reference to FIG. 1. For example, the adapter device initialization and activation 302 includes the adapter device 106 being initialized and activated for wired/wireless communication (e.g., wired/wireless operations).

In various examples, the signal flow 300 includes an electronic device detection process (or “electronic device detection”) (or “detection”) 304 being performed by the electronic device 102, the adapter device 106, and the electronic device 108, or any combination thereof. In various examples, the detection 304 includes the electronic device 102, using the adapter device 106, detecting the electronic device 108, in a similar way as discussed above with reference to FIG. 1. For instance, the electronic device 102 uses transceivers (e.g., a wired transceiver) (e.g., a universal serial bus (USB) transceiver) (e.g., a wireless transceiver) (e.g., a near field communications (NFC) transceiver) in the adapter device 106 to detect, via the wireless transceiver in the adapter device 106, a transceiver (e.g., a wireless transceiver) (e.g., an NFC transceiver) in the electronic device 108.

In some examples, the signal flow 300 includes a pairing request communication (e.g., an NFC pairing request transmission) (or “NFC pairing request”) 306 being performed by the electronic device 108. The electronic device 108 performs the NFC pairing request 306 by transmitting a pairing request signal (e.g., an NFC pairing request signal) to the electronic device 102. In various examples, the pairing request signal, which includes a wireless pairing request signal, is received utilizing the adapter device 106 and via the wireless transceiver in the adapter device 106, converted to a wired pairing request signal, and routed to the electronic device 108, via the wired transceiver in the adapter device 106.

In various examples, the pairing request 306 includes pairing request values associated with the electronic device 108. For instance, the pairing request values include an identifier, an authentication flag, a type of information, or any combination thereof.

In some examples, the signal flow 300 includes a pairing request communication (e.g., a USB pairing request transmission) (or “USB pairing request”) 308 being performed utilizing the adapter device 106, in response to instructions (e.g., operations) processed by the electronic device 102. The adapter device 106, being controlled by the electronic device 102 to perform the USB pairing request 308, is utilized to convert a wireless pairing request signal (e.g., an NFC pairing request signal), which is received from the electronic device 108, to a wired pairing request signal (e.g., an NFC pairing request signal), and routes (e.g., transmits) the wired pairing request signal to the electronic device 102. In various cases, the pairing request 308 includes any of the pairing request values that are included in the pairing request 306.

In some examples, the signal flow 300 includes a pairing response communication (e.g., a USB pairing response transmission) (or “USB pairing response”) 310 being performed by the electronic device 102. The USB pairing response 310 is performed by the electronic device 102 transmitting a pairing response signal (e.g., a USB pairing response signal) by utilizing the adapter device 106, in response to the electronic device 102 authenticating the electronic device 108.

In some cases, the electronic device 102 authenticates the electronic device 108 in response to pairing request values. In various examples, the electronic device 102 identifies the identifier, the authentication flag, the type of information, or any combination thereof, in the USB pairing request 308. (e.g., a value identifying the information type). In some cases, the electronic device 102 analyzes the identifier, the authentication flag, the type of information, or any combination thereof, and identifies whether the identifier, the authentication flag, the type of information, or any combination thereof, match corresponding other pairing request values (e.g., predetermined pairing request values), such as pairing request values stored (e.g., previously stored) in the electronic device 102.

In some cases, the electronic device 102 identifies the electronic device 108 as being authenticated in response to the pairing request values matching the corresponding predetermined pairing request values, the pairing request values satisfying corresponding pairing request value characteristics, or any combination thereof. A pairing response, which is communicated as a wired pairing response (e.g., a USB pairing response), via the USB pairing response 310, is transmitted by the electronic device utilizing the adapter device 106, in response to the electronic device 108 being authenticated.

In various examples, the signal flow 300 includes a pairing response communication (e.g., an NFC pairing response transmission) (or “NFC pairing response”) 312 being performed utilizing the adapter device 106, which is controlled by the electronic device 102, in response to instructions (e.g., operations) processed by the electronic device 102. The NFC pairing response 312 is performed utilizing the adapter device 106, being controlled by the electronic device 102, to transmit a pairing response signal (e.g., a wireless pairing request signal) (e.g., an NFC pairing response signal) to the electronic device 108, in response to the electronic device 102 authenticating the electronic device 108. In some cases, the adapter device 106 is utilized by the electronic device 102 to convert the response signal, which is received as the USB pairing response signal, to the NFC pairing response signal, and routes the response signal, as the NFC pairing response signal, to the electronic device 108.

In some cases, the electronic device 102, via the adapter device 106, communicates with the electronic device 108 by performing a communication exchange process (or “communication exchange”) 314. For instance, the electronic device 102, the adapter device 106, and the electronic device 108 perform the communication exchange 314, in response to the adapter device initialization and activation 302, the electronic device detection 304, the NFC pairing request 306, the USB pairing request 308, the USB pairing response 310, or the NFC pairing response 312, or any combination thereof, in a similar way as discussed above with reference to FIG. 1.

In some cases, the communication exchange 314 includes communications (e.g., radio frequency (RF) transmissions of any type) (e.g., NFC transmissions) being transmitted by the electronic device 108 and to the electronic device 102, via the adapter device 106, which routes the NFC transmissions to the electronic device 102 as wired transmissions (e.g., USB transmissions). In various examples, the communication exchange 314 includes communications (e.g., USB transmissions) being transmitted by the electronic device 102, via the adapter device 106, and to the electronic device 108, in response to the adapter device 106 being utilized by the electronic device 102 to route the wired transmissions (e.g., USB transmissions) to the electronic device 108 as RF transmissions (e.g., NFC transmissions).

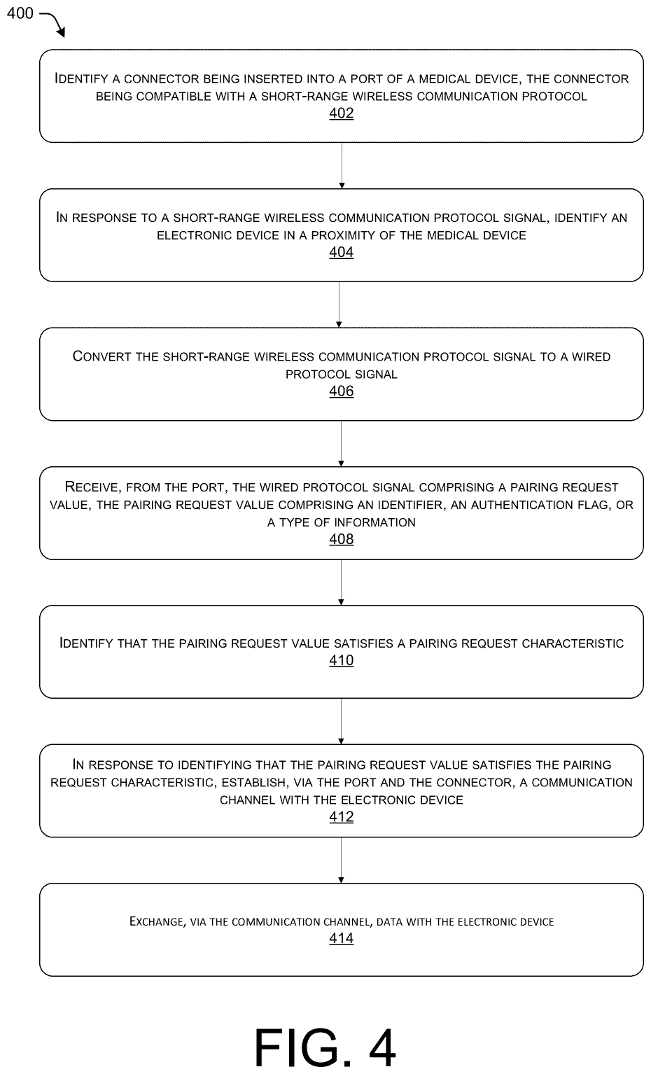

FIG. 4 illustrates example process 400 for utilizing conversions between multiple communication protocols for secure communications between devices. The devices for which the secure communications are performed include the electronic device 102 and the electronic device 108, the electronic device 102 being communicatively coupled to the adapter device 106, as discussed above with reference to FIGS. 1-3.

At 402, the electronic device 102 identifies a connector (e.g., the adapter device 106) being inserted into a port (e.g., the communications connection device 104) of a medical device (e.g., the electronic device 102) (e.g., a sensor, or any other type of medical device or non-medical device), the connector (e.g., the adapter device 106) being compatible with wireless protocol (e.g., a short-range wireless communication protocol). In some examples, the port (e.g., the communications connection device 104) includes a universal serial bus (USB) port. In those or other examples, the wireless protocol includes a near field communications (NFC) protocol.

At 404, the electronic device 102, in response to a wireless signal (e.g., a short-range wireless communication protocol signal) (e.g., the NFC pairing request 306), identifies an electronic device (e.g., the electronic device 108) in a proximity of the electronic device 102. For instance, the electronic device 108 being in the proximity of the electronic device 102 includes the electronic device 102 and the electronic device 108 being positioned with the distance between the electronic device 102 and the electronic device 108 being less than the threshold distance

At 406, the electronic device 102 converts the short-range wireless communication protocol signal (e.g., the NFC signal) to a wired protocol signal (e.g., a USB signal). The short-range wireless communication protocol signal is converted by the electronic device 102 utilizing the adapter device 106 to receive the short-range wireless communication protocol signal and convert the short-range wireless communication protocol signal to the USB signal.

At 408, the electronic device 102 receives, from the port, the wired protocol signal comprising a pairing request value, the pairing request value comprising an identifier, an authentication flag, or a type of information. In some examples, the pairing request value is received in a group of pairing request values being received, the pairing request values including the identifier, an authentication flag, and a type of information.

At 410, the electronic device 102 identifies that the pairing request value satisfies a pairing request characteristic. The electronic device 102, for example, identifies that the pairing request value satisfies the pairing request characteristic in response to performing a comparison between the pairing request value and the pairing request characteristic, and identifying that a result of the comparison is “positive,” indicating that the pairing request value satisfies the pairing request characteristic. In other cases, another pairing request value not satisfying the pairing request characteristic is in response to another comparison (e.g., a previous comparison for another electronic device pairing) between the other pairing request value and the pairing request characteristic, and identifying that another result of the other comparison is “negative,” indicating that the other pairing request value does not satisfy the pairing request characteristic (e.g., another identifier, another authentication flag, or another type of information not matching a predetermined identifier, a predetermined authentication flag, or a predetermined type of information, respectively).

At 412, the electronic device 102 in response to identifying that the pairing request value satisfies the pairing request characteristic, establishes, via the port and the connector, a communication channel with the electronic device. For example, the electronic device 102 establishes the communication channel, as part of the wired/wireless operations being performed by the electronic device, 102, the adapter device 106, and the electronic device 108.

At 414, the electronic device 102 exchanges, via the communication channel, data with the electronic device. The wired/wireless operations include communicating being performed between the electronic device 102 and the electronic device 108 using the communication channel (e.g., a secure communication channel).

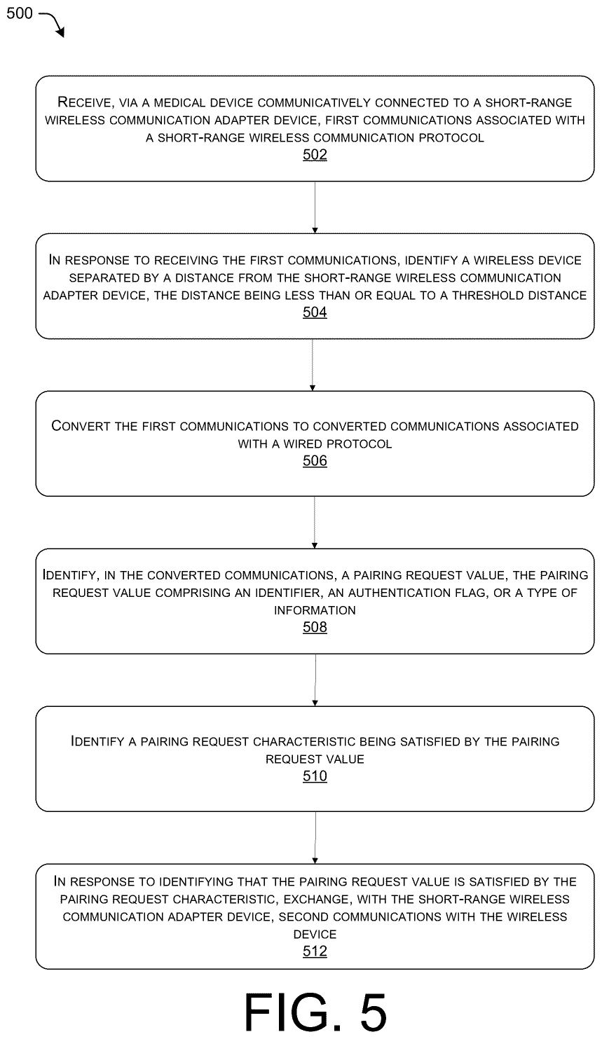

FIG. 5 illustrates example process 500 for utilizing conversions between multiple communication protocols for secure communications between devices. The devices for which the secure communications are performed include the electronic device 102 and the electronic device 108, the electronic device 102 being communicatively coupled to the adapter device 106, as discussed above with reference to FIGS. 1-3.

At 502, the electronic device 102 receiving, via a medical device (e.g., the electronic device 102) communicatively connected to a short-range wireless communication adapter device (e.g., the adapter device 106, first communications associated with a short-range wireless communication protocol (e.g., an NFC protocol). In various examples, the adapter device 106 is activated in response to performance of various adapter device related operations (e.g., an activation of the adapter device 106).

At 504, the electronic device 102 in response to receiving the first communications, identifying a wireless device (e.g., the electronic device 108) separated by a distance from the short-range wireless communication adapter device (e.g., the adapter device 106), the distance being less than or equal to a threshold distance. For example, the electronic device 102 performs a detection operation to identify whether a distance between a transceiver (e.g., an antenna of the communications connection device 110) of the electronic device 108 and a transceiver (e.g., an antenna of the adapter device 106) is less than or equal to a threshold distance.

At 506, the electronic device 102 converting the first communications to converted communications associated with a wired protocol. In some cases, the electronic device 102 performs a conversion operation utilizing the adapter device 106. The conversion operation is performed, for example, by the electronic device 102 utilizing the adapter device 106 to convert NFC signals transmitted by the electronic device 108 to USB signals received by the electronic device 102.

At 508, the electronic device 102 identifying, in the converted communications, a pairing request value, the pairing request value comprising an identifier, an authentication flag, or a type of information. The electronic device 102 compares, as part of a pairing process, the pairing request value to a predetermined pairing characteristic to identify whether the pairing request value satisfies the predetermined pairing characteristic.

At 510, the electronic device 102 identifying a pairing request characteristic being satisfied by the pairing request value. The electronic device 102 identifies the pairing request characteristic being satisfied by the pairing request value in response to the result of the comparison being “positive.”

At 512, the electronic device 102 in response to identifying that the pairing request value is satisfied by the pairing request characteristic, exchanging, with the short-range wireless communication adapter device, second communications with the wireless device. The electronic device 102 exchanges data, via the second communications, in response to completion of the pairing operations.

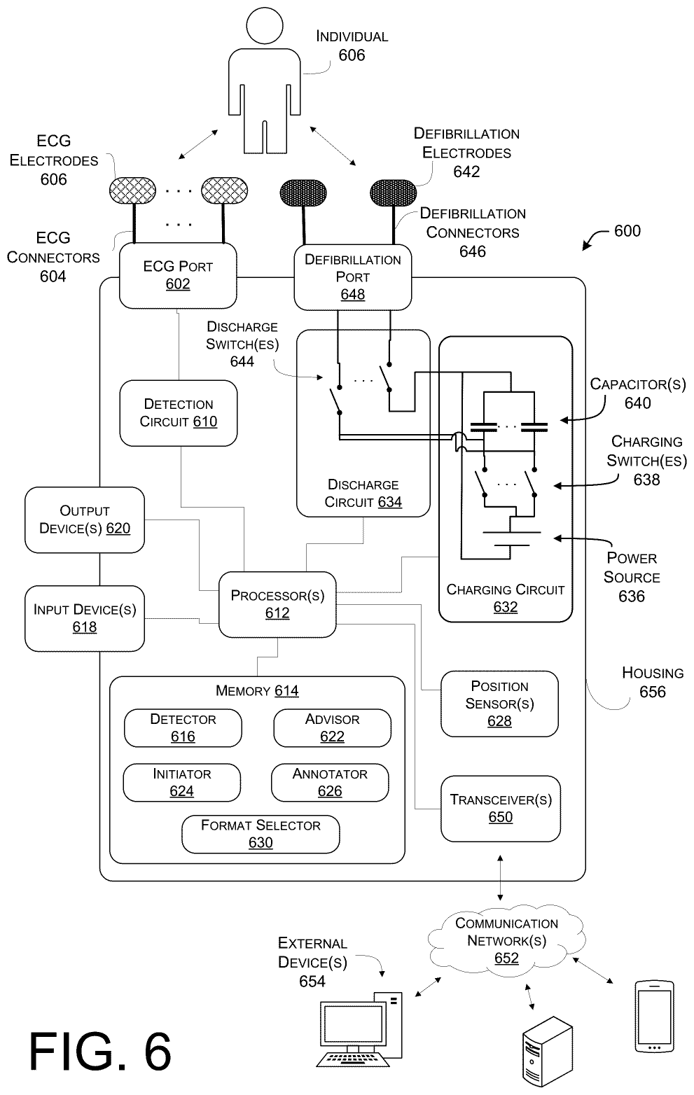

FIG. 6 illustrates an example of an external defibrillator 600 configured to perform various functions described herein. For example, the external defibrillator 600 is utilized to implement the electronic device 102 described above with reference to FIGS. 1 to 5.

The external defibrillator 600 includes an ECG port 602 connected to multiple ECG connectors 604. In some cases, the ECG connectors 604 are removeable from the ECG port 602. For instance, the ECG connectors 604 are plugged into the ECG port 602. The ECG connectors 604 are connected to ECG electrodes 606, respectively. In various implementations, the ECG electrodes 606 are disposed on different locations on an individual 608. A detection circuit 610 is configured to detect relative voltages between the ECG electrodes 606. These voltages are indicative of the electrical activity of the individual's 608 heart.

In various implementations, the ECG electrodes 606 are in contact with the different locations on the individual's 608 skin. In some examples, a first one of the ECG electrodes 606 is placed on the skin between the heart and right arm of the individual 608, a second one of the ECG electrodes 606 is placed on the skin between the heart and left arm of the individual 608, and a third one of the ECG electrodes 606 is placed on the skin between the heart and a leg (either the left leg or the right leg) of the individual 608. In these examples, the detection circuit 608 is configured to measure the relative voltages between the first, second, and third ECG electrodes 606. Respective pairings of the ECG electrodes 606 are referred to as “leads,” and the voltages between the pairs of ECG electrodes 606 are known as “lead voltages.” In some examples, more than three ECG electrodes 606 are included, such that 5-lead or 12-lead ECG signals are detected by the detection circuit 610.

The detection circuit 610 includes at least one analog circuit, at least one digital circuit, or a combination thereof. The detection circuit 610 receives the analog electrical signals from the ECG electrodes 606, via the ECG port 602 and the ECG leads 604. In some cases, the detection circuit 610 includes one or more analog filters configured to filter noise and/or artifact from the electrical signals. The detection circuit 610 includes an analog-to-digital (ADC) in various examples. The detection circuit 610 generates a digital signal indicative of the analog electrical signals from the ECG electrodes 606. This digital signal can be referred to as an “ECG signal” or an “ECG.”

In some cases, the detection circuit 610 further detects an electrical impedance between at least one pair of the ECG electrodes 606. For example, the detection circuit 610 includes, or otherwise controls, a power source that applies a known voltage across a pair of the ECG electrodes 606 and detects a resultant current between the pair of the ECG electrodes 606. The impedance is generated based on the applied voltage and the resultant current. In various cases, the impedance corresponds to respiration of the individual 608, chest compressions performed on the individual 608, and other physiological states of the individual 608. In various examples, the detection circuit 610 includes one or more analog filters configured to filter noise and/or artifact from the resultant current. The detection circuit 610 generates a digital signal indicative of the impedance using an ADC. This digital signal can be referred to as an “impedance signal” or an “impedance.”

The detection circuit 610 provides the ECG signal and/or the impedance signal one or more processors 612 in the external defibrillator 600. In some implementations, the processor(s) 612 includes a central processing unit (CPU), a graphics processing unit (GPU), both CPU and GPU, or other processing unit or component known in the art.

The processor(s) 612 is operably connected to memory 614. In various implementations, the memory 612 is volatile (such as random-access memory (RAM)), non-volatile (such as read only memory (ROM), flash memory, etc.) or some combination of the two. The memory 614 stores instructions that, when executed by the processor(s) 612, causes the processor(s) 612 to perform various operations. In various examples, the memory 614 stores methods, threads, processes, applications, objects, modules, any other sort of executable instruction, or a combination thereof. In some cases, the memory 614 stores files, databases, or a combination thereof. In some examples, the memory 614 includes RAM, ROM, electrically erasable programmable read-only memory (EEPROM), flash memory, or any other memory technology. In some examples, the memory 614 includes one or more of CD-ROMs, digital versatile discs (DVDs), content-addressable memory (CAM), or other optical storage, magnetic cassettes, magnetic tape, magnetic disk storage or other magnetic storage devices, or any other medium which can be used to store the desired information and which can be accessed by the processor(s) 612 and/or the external defibrillator 600. In some cases, the memory 614 at least temporarily stores the ECG signal and/or the impedance signal.

In various examples, the memory 614 includes a detector 616, which causes the processor(s) 612 to determine, based on the ECG signal and/or the impedance signal, whether the individual 608 is exhibiting a particular heart rhythm. For instance, the processor(s) 612 determines whether the individual 608 is experiencing a shockable rhythm that is treatable by defibrillation. Examples of shockable rhythms include ventricular fibrillation (VF) and pulseless ventricular tachycardia (V-Tach). In some examples, the processor(s) 612 determines whether any of a variety of different rhythms (e.g., asystole, sinus rhythm, atrial fibrillation (AF), etc.) are present in the ECG signal.

In some implementations, the processor(s) 612 is operably connected to one or more input/output devices. For instance, the input/output devices include one or more input devices 618, one or more output devices 620, one or more other input/output devices, or any combination thereof. Collectively, the input device(s) 618 and the output device(s) 620 function as an interface between a user and the defibrillator 600. The input device(s) 618 is configured to receive an input from a user and includes at least one of a keypad, a cursor control, a touch-sensitive display, a voice input device (e.g., a speaker), a haptic feedback device, or any combination thereof. The output device(s) 620 includes at least one of a display, a speaker, a haptic output device, a printer, or any combination thereof. In various examples, the processor(s) 612 causes a display among the input/output device(s) (e.g., the input device(s) 618) to visually output a waveform of the ECG signal and/or the impedance signal. In some implementations, the input device(s) 618 includes one or more touch sensors, the input/output device(s) (e.g., the output device(s) 620) includes a display screen, and the touch sensor(s) are integrated with the display screen. Thus, in some cases, the external defibrillator 600 includes a touchscreen configured to receive user input signal(s) and visually output physiological parameters, such as the ECG signal and/or the impedance signal.

In some examples, the input/output devices include the other input/output devices of various types, the other input/output devices including one or more universal serial bus (USB) connection devices. In those or other examples, the USB connection device(s) are utilized to implement one or more of the communications connection devices 104 described above with reference to FIGS. 1-5, one or more other communications connection devices of various types, or any combination thereof.

In some examples, the memory 614 includes an advisor 622, which, when executed by the processor(s) 612, causes the processor(s) 612 to generate advice and/or control the output device(s) 620 to output the advice to a user (e.g., a rescuer). In some examples, the processor(s) 612 provides, or causes the output device(s) 620 to provide, an instruction to perform CPR on the individual 608. In some cases, the processor(s) 612 evaluates, based on the ECG signal, the impedance signal, or other physiological parameters, CPR being performed on the individual 608 and causes the output device(s) 620 to provide feedback about the CPR in the instruction. According to some examples, the processor(s) 612, upon identifying that a shockable rhythm is present in the ECG signal, causes the output device(s) 620 to output an instruction and/or recommendation to administer a defibrillation shock to the individual 608.

The memory 614 also includes an initiator 624 which, when executed by the processor(s) 612, causes the processor(s) 612 to control other elements of the external defibrillator 600 in order to administer a defibrillation shock to the individual 608. In some examples, the processor(s) 612 executing the initiator 624 selectively causes the administration of the defibrillation shock based on determining that the individual 608 is exhibiting the shockable rhythm and/or based on an input from a user (received, e.g., by the input/output device(s) (e.g., the input device(s) 618)). In some cases, the processor(s) 612 causes the defibrillation shock to be output at a particular time, which is determined by the processor(s) 612 based on the ECG signal and/or the impedance signal.

In various cases, the memory 614 includes an annotator 626 which, when executed by the processor(s) 612, causes the processor(s) 612 to generate ECG data based on the ECG signal and to generate annotation data associated with the ECG data based on an input signal received by the input device(s) 616. For example, a touchscreen of the input/output device(s) (e.g., the input device(s) 618) receives a signal indicative of a note associated with a lead of the ECG signal and the processor(s) 612 generate the annotation data based on the note. In some cases, the annotator 626 causes the processor(s) 612 to generate the annotation data by performing handwriting recognition or natural language processing based on the signal indicative of the note. In some cases, a microphone of the input/output device(s) (e.g., the input device(s) 618) receives a signal indicative of the note and the processor(s) 612 generate the annotation data based on the note. For example, the annotator 626 causes the processor(s) 612 to generate the annotation data by performing speech recognition on the signal indicative of the note.

In some examples, the annotations or notes are stored as a transparency or image layer. When displayed, the annotations or notes are visually overlaid on the ECG, in various cases. According to some implementations, the annotator 626 causes the image layer including the annotations or notes to appear or disappear over the ECG on an output device (e.g., a screen).

According to various examples, the processor(s) 612 are operably connected to one or more position sensors 628. The position sensor(s) 628 are configured to identify a position, movement, or orientation of the external defibrillator 600. For example, the position sensor(s) 628 include a location service circuit (e.g., a Global Navigation Satellite System (GNSS) circuit, such as a Global Positioning System (GPS) circuit) configured to identify the position of the external defibrillator 600, an accelerometer configured to identify an acceleration of the external defibrillator 600, or a gyroscope configured to identify the orientation of the external defibrillator 600.

The memory 614 further includes a format selector 630, in various examples. When executed by the processor(s) 612, the format selector 630 causes the processor(s) 612 to identify a selected arrangement of graphical elements indicating the ECG leads of the ECG signal and to cause a screen of the input/output device(s) (e.g., the output device(s) 620) to output the graphical elements in the selected arrangement. In some examples, the selected arrangement is a first arrangement (e.g., a Cabrera arrangement) or a second arrangement (e.g., a standard arrangement) of the ECG leads. According to various examples, the screen is rectangular, the first arrangement is a portrait arrangement, and the second arrangement is a landscape arrangement. The format selector 630, when executed by the processor(s) 612, causes the processor(s) 612 to identify the selected arrangement based on a format selection. In some cases, the processor(s) 612 identify the format selection based on a touchscreen of the input/output device(s) (e.g., the input device(s) 618) receiving an input signal associated with a selectable GUI element (e.g., a touch input signal associated with a button or slider element output by the touchscreen), based on a button of the input/output device(s) (e.g., the input device(s) 618) receiving an input signal, or based on a microphone of the input device(s) 618 receiving an auditory input signal. In some implementations, the processor(s) 612 identify the format selection based on a position, movement, or orientation of the external defibrillator 600 that is detected by the position sensor(s) 628. For instance, the processor(s) 612 determines that the first arrangement is the selected arrangement if the gyroscope of the position sensor(s) 628 detects that the screen of the external defibrillator 600 is oriented in a first orientation and determines that the second arrangement is the selected arrangement if the gyroscope of the position sensor(s) 628 detects that the screen of the external defibrillator 600 is oriented in a second orientation. In some cases, the processor(s) 612 determines that the selected arrangement switches between one arrangement and the other arrangement when the position sensor(s) 628 determines that the screen of the external defibrillator has been physically rotated greater than a threshold angle (e.g., an angle that is greater than 0 degrees and less than or equal to 90 degrees).

The format selector 630, in some implementations, causes the screen to output multiple graphical elements simultaneously. For instance, twelve graphical elements, respectively corresponding to twelve ECG leads, are output on the screen simultaneously. In some cases, fifteen graphical elements, respectively corresponding to fifteen ECG leads, are output on the screen simultaneously. For example, one of the arrangements may include the graphical elements in six rows and two columns, and another one of the arrangements may include the graphical elements in three rows and four columns.

The processor(s) 612 is operably connected to a charging circuit 632 and a discharge circuit 634. In various implementations, the charging circuit 632 includes a power source 636, one or more charging switches 638, and one or more capacitors 640. The power source 636 includes, for instance, a battery. The processor(s) 612 initiates a defibrillation shock by causing the power source 636 to charge at least one capacitor among the capacitor(s) 640. For example, the processor(s) 612 activates at least one of the charging switch(es) 638 in the charging circuit 632 to complete a first circuit connecting the power source 636 and the capacitor to be charged. Then, the processor(s) 612 causes the discharge circuit 634 to discharge energy stored in the charged capacitor across a pair of defibrillation electrodes 640, which are in contact with the individual 608. For example, the processor(s) 612 deactivates the charging switch(es) 638 completing the first circuit between the capacitor(s) 640 and the power source 636, and activates one or more discharge switches 644 completing a second circuit connecting the charged capacitor 640 and at least a portion of the individual 608 disposed between defibrillation electrodes 642.

The energy is discharged from the defibrillation electrodes 642 in the form of a defibrillation shock. For example, the defibrillation electrodes 642 are connected to the skin of the individual 608 and located at positions on different sides of the heart of the individual 608, such that the defibrillation shock is applied across the heart of the individual 608. The defibrillation shock, in various examples, depolarizes a significant number of heart cells in a short amount of time. The defibrillation shock, for example, interrupts the propagation of the shockable rhythm (e.g., VF or pulseless V-Tach) through the heart. In some examples, the defibrillation shock is 200 J or greater with a duration of 0.015 seconds. In some cases, the defibrillation shock has a multiphasic (e.g., biphasic) waveform. The discharge switch(es) 644 are controlled by the processor(s) 612, for example. In various implementations, the defibrillation electrodes 642 are connected to defibrillation connectors 646. The defibrillation connectors 646 are connected to a defibrillation port 648, in implementations. According to various examples, the defibrillation connectors 646 are removable from the defibrillation port 648. For example, the defibrillation connectors 646 are plugged into the defibrillation port 648.

In various implementations, the processor(s) 612 is operably connected to one or more transceivers 650 that transmit and/or receive data over one or more communication networks 652. For example, the transceiver(s) 650 includes a network interface card (NIC), a network adapter, a local area network (LAN) adapter, or a physical, virtual, or logical address to connect to the various external devices and/or systems. In various examples, the transceiver(s) 650 includes any sort of wireless transceivers capable of engaging in wireless communication (e.g., radio frequency (RF) communication). For example, the communication network(s) 652 includes one or more wireless networks that include a 3rd Generation Partnership Project (3GPP) network, such as a Long Term Evolution (LTE) radio access network (RAN) (e.g., over one or more LE bands), a New Radio (NR) RAN (e.g., over one or more NR bands), or a combination thereof. In some cases, the transceiver(s) 650 includes other wireless modems, such as a modem for engaging in WI-FI®, WIGIG®, WIMAX®, BLUETOOTH®, or infrared communication over the communication network(s) 652.

The defibrillator 600 is configured to transmit and/or receive data (e.g., ECG data, notation data, impedance data, data indicative of one or more detected heart rhythms of the individual 608, data indicative of one or more defibrillation shocks administered to the individual 608, etc.) with one or more external devices 654 via the communication network(s) 652. The external devices 654 include, for instance, mobile devices (e.g., mobile phones, smart watches, etc.), Internet of Things (IoT) devices, medical devices, computers (e.g., laptop devices, servers, etc.), or any other type of computing device configured to communicate over the communication network(s) 652. In some examples, the external device(s) 654 is located remotely from the defibrillator 600, such as at a remote clinical environment (e.g., a hospital). According to various implementations, the processor(s) 612 causes the transceiver(s) 650 to transmit data to the external device(s) 654. In some cases, the transceiver(s) 650 receives data from the external device(s) 654 and the transceiver(s) 650 provide the received data to the processor(s) 612 for further analysis.

In various implementations, the external defibrillator 600 also includes a housing 656 that at least partially encloses other elements of the external defibrillator 600. For example, the housing 656 encloses the detection circuit 610, the processor(s) 612, the memory 614, the charging circuit 632, the transceiver(s) 650, or any combination thereof. In some cases, the input device(s) 618 and output device(s) 620 extend from an interior space at least partially surrounded by the housing 656 through a wall of the housing 656. In various examples, the housing 656 acts as a barrier to moisture, electrical interference, and/or dust, thereby protecting various components in the external defibrillator 600 from damage.

In some implementations, the external defibrillator 600 is an automated external defibrillator (AED) operated by an untrained user (e.g., a bystander, layperson, etc.) and can be operated in an automatic mode. In automatic mode, the processor(s) 612 automatically identifies a rhythm in the ECG signal, makes a decision whether to administer a defibrillation shock, charges the capacitor(s) 640, discharges the capacitor(s) 640, or any combination thereof. In some cases, the processor(s) 612 controls the output device(s) 620 to output (e.g., display) a simplified user interface to the untrained user. For example, the processor(s) 612 refrains from causing the output device(s) 620 to display a waveform of the ECG signal and/or the impedance signal to the untrained user, in order to simplify operation of the external defibrillator 600.

In some examples, the external defibrillator 600 is a monitor-defibrillator utilized by a trained user (e.g., a clinician, an emergency responder, etc.) and can be operated in a manual mode or the automatic mode. When the external defibrillator 600 operates in manual mode, the processor(s) 612 cause the output device(s) 620 to display a variety of information that may be relevant to the trained user, such as waveforms indicating the ECG data and/or impedance data, notifications about detected heart rhythms, and the like.

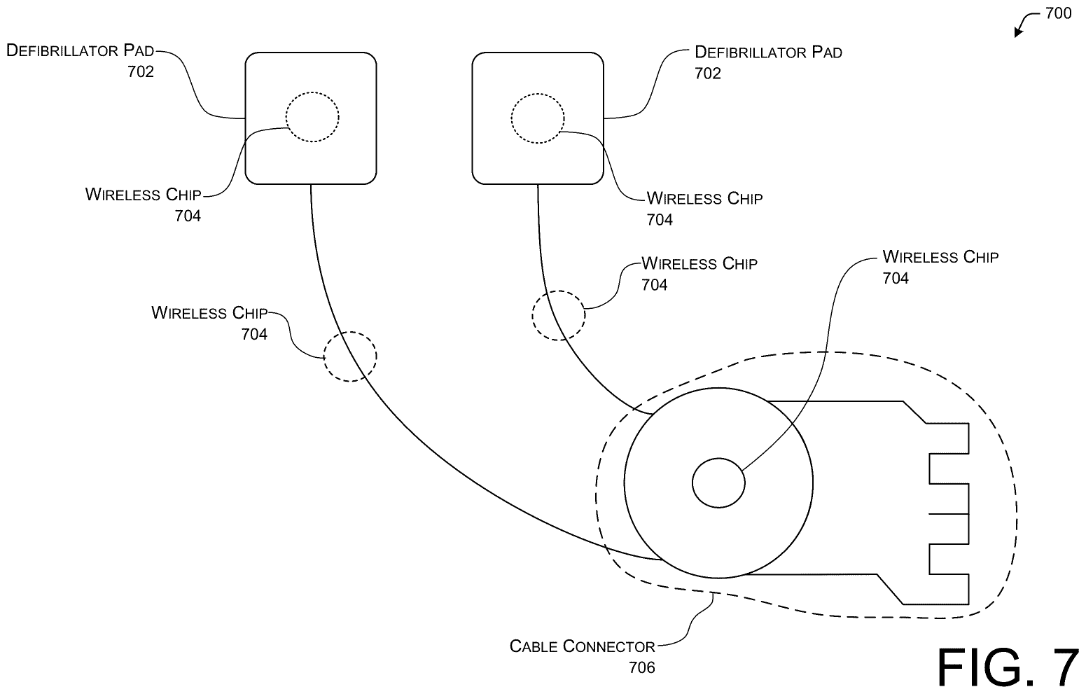

FIG. 7 illustrates an example of a defibrillator pad cable connector 700 configured to be coupled to a monitoring device with a universal serial bus (USB) device, via a near field communication (NFC) compatible connector. In some examples, the defibrillator pad cable connector 700 includes one or more defibrillator pads (e.g., a defibrillator pad 702) and is utilized to implement the electronic device 108 described above with reference to FIGS. 1-6. In those or other examples, the defibrillator pad cable connector 700 includes one or more wireless chips (e.g., a wireless chip 704). In those or other examples, any of one or more defibrillator pads 702 is utilized to implement one or more pads associated with one or more of the defibrillation electrodes 642, respectively, described above with reference to FIG. 6. In those or other examples, any of one or more wireless chips 704 is utilized to implement the communications connection device 110 described above with reference to FIGS. 1-6. In various instances, the defibrillator pad cable connector 700 includes a cable connector 706 (or “therapy cable connector”).

In various implementations, the wireless chip(s) 704 are coupled to, included in, assembled on, attached to, integrated within, etc., or any combination thereof, any portions of the defibrillator pad cable connector 700. In some examples, any of the wireless chip(s) 704 are coupled to, included in, assembled on, attached to, integrated within, etc., or any combination thereof, any of the defibrillator pads 702. In alternative or additional examples, any of the wireless chip(s) 704 are coupled to, included in, assembled on, attached to, integrated within, etc., or any combination thereof, the cable connector 706. In alternative or additional examples, any of the wireless chip(s) 704 are coupled to, included in, attached to, integrated within, etc., or any combination thereof, any of one or more cables of the defibrillator pad cable connector 700.

In various implementations, any of the wireless chip(s) 704 can be utilized according to any techniques as discussed with respect to the communications connection device 110 throughout the current disclosure, In some instances, any of the wired/wireless operations as discussed above with reference to FIG. 1 can be performed utilizing the wireless chip(s) 704 to establish communications for the defibrillator pad cable connector 700, such as by utilizing a single wireless chip 704. For example, the communications for the defibrillator pad cable connector 700 is established, performed, and/or maintained utilizing a single chip (e.g., any of the wireless chip(s) 704) in response to pairing being established between the electronic device 102 and the any of the wireless chip(s) 704.

In those or other instances, any of the wired/wireless operations as discussed above with reference to FIGS. 1-6 can be performed utilizing the wireless chip(s) 704 to establish communications for any portion of the defibrillator pad cable connector 700, such as by utilizing a single wireless chip 704, such as by establish communications for any relevant portion (e.g., a defibrillator pad 702, a cable connector 706, a wire between the defibrillator pad 702 and the cable connector 706, etc.) of the defibrillator pad cable connector 700 utilizing a single wireless chip 704 associated with the defibrillator pad 702, the cable connector 706, the wire between the defibrillator pad 702 and the cable connector 706, etc., respectively. For example, the communications for the relevant portion of the defibrillator pad cable connector 700 is established utilizing the wireless chip 704 in response to pairing being established between the electronic device 102 and the corresponding wireless chip 704 associated with the relevant portion of the defibrillator pad cable connector 700 (e.g., the communications for the cable connector 706 is utilizing the wireless chip 704 in response to pairing being established between the electronic device 102 and the corresponding wireless chip 704 associated with the cable connector 706).

In those or other instances, any of the wired/wireless operations as discussed above with reference to FIGS. 1-6 can be performed utilizing the wireless chip(s) 704 to establish communications for the defibrillator pad cable connector 700, such as by utilizing a combination of the wireless chip(s) 704. For example, the communications for the defibrillator pad cable connector 700 is established, performed, and/or maintained utilizing a combination of the wireless chip(s) 704 in response to paring being established between the electronic device 102 and all of the combination.

### Example Clauses

1: A system, comprising: a connector configured to exchange radio frequency (RF) communication signals using RF communication protocols; an electronic device; and a medical device comprising: a power supply; a port configured to exchange wired signals using a wired protocol, the port configured to receive the connector; and a processor configured to: identify the connector being inserted into the port; receive first data from the connector, the first data identifying an RF communication protocol; activate the connector by connecting, via the port, the connector to the power supply; identify the electronic device being positioned at a distance from the connector, the distance being less than or equal to a threshold distance associated with the RF communication protocol; receive, from the electronic device, second data in a communication associated with the RF communication protocol; convert the second data associated with the RF communication protocol to converted data associated with the wired protocol; identify that a pairing request value in the converted data satisfies a pairing request characteristic, the pairing request value comprising an identifier, an authentication flag, or a type of information; in response to identifying that the pairing request value satisfies the pairing request characteristic, pair the electronic device and the connector; in response to pairing the electronic device and the connector, establish, via the port and the connector, a communication channel with the electronic device; and utilizing the communication channel to exchange third data with the electronic device.
2: The system of clause 1, wherein: the connector comprises a first short-range wireless communication antenna associated with a first short-range wireless communication protocol; and the electronic device comprises a second short-range wireless communication antenna associated with a second short-range wireless communication protocol being a same protocol as the first short-range wireless communication protocol.
3: The system of clause 1 or 2, wherein the electronic device comprises an electrocardiogram (ECG) sensor, a blood oxygenation sensor, a capnography sensor, an invasive blood pressure (IBP) sensor, a non-invasive blood pressure sensor, a mechanical cardio pulmonary respiratory (CPR) device, a logistical sensor, a location sensor or a CPR feedback device.
4: A method, comprising: identifying a connector being inserted into a port of a medical device, the connector being compatible with a short-range wireless communication protocol; in response to a short-range wireless communication protocol signal, identifying an electronic device in a proximity of the medical device; converting the short-range wireless communication protocol signal to a wired protocol signal; receiving, from the port, the wired protocol signal comprising a pairing request value, the pairing request value comprising an identifier, an authentication flag, or a type of information; identifying that the pairing request value satisfies a pairing request characteristic; in response to identifying that the pairing request value satisfies the pairing request characteristic, establishing, via the port and the connector, a communication channel with the electronic device; and exchanging, via the communication channel, data with the electronic device.
5: The method of clause 4, wherein activating the connector further comprises activating the connector in response to the connector being inserted into the port.
6: The method of clause 4 or 5, wherein activating the connector further comprises activating the connector in response to the medical device being activated.
7: The method of any of clauses 4-6, further comprising: operating the medical device in a payment functionality mode, an inventory control mode, an asset management mode, an employee management functionality, a location services mode, or a patient recording keeping mode.
8: The method of any of clauses 4-7, wherein the short-range wireless communication protocol signal comprises a near field communication (NFC) signal, and the wired protocol signal comprises a universal serial bus (USB) signal.
9: The method of any of clauses 4-8, wherein receiving the wired protocol signal further comprises receiving, via the port, the wired protocol signal comprising a security key provided by the electronic device, and wherein establishing the communication channel further comprises establishing the communication channel with the electronic device, in response to verifying the security key is a valid security key.
10: The method of any of clauses 4-9, wherein the short-range wireless communication protocol signal is received by an antenna for the connector, and the antenna satisfies a power characteristic, a wavelength characteristic, or a frequency characteristic associated with the short-range wireless communication protocol.
11: The method of any of clauses 4-10, wherein establishing the communication channel further comprises: presenting, via a display of the medical device, a notification indicating whether the electronic device is authenticated; receiving a user selection via user input to an input device of the medical device; and performing an action in response to the user selection, the action comprising establishing the communication channel or exchanging a message with an external device.
12: The method of any of clauses 4-11, wherein the electronic device comprises a sensor bundle, the sensor bundle comprising electrodes utilized to capture data representing electrical signals indicative of an electrical activity of a heart of an individual, and wherein identifying the sensor bundle further comprises: identifying, via a first short-range wireless communication transceiver of the connector, a second short-range wireless communication transceiver associated with a housing comprising the sensor bundle, and establishing, via the port and the connector, the communication channel with a sensor of the sensor bundle in response to a third short-range wireless communication transceiver of the sensor bundle being identified as being within a distance of the second short-range wireless communication transceiver as the sensor is being pulled out of the housing.
13: The method of any of clauses 4-12, wherein identifying the electronic device further comprises: identifying the electronic device in response to an activation selection being received and the connector being activated, the activation selection being received via user input identified by an input device of the medical device, the connector being activated by power received from the port.
14: A system, comprising: a connector; an external electronic device; and a medical device; a display; an input device; a power supply; a port comprising a port circuit associated with a wired protocol, the port configured to receive the connector comprising a circuit associated with a radio frequency (RF) communication protocol; and a processor configured to: present, via the display, an activation notification associated with the connector; receive an activation selection via user input to the input device; activate the connector by connecting, via the port, the connector to the power supply; identify the external electronic device being positioned within a threshold distance of the connector; receive, from the external electronic device, an identifier in a communication associated with the RF communication protocol; in response to receiving the identifier, pairing the external electronic device and the medical device via the connector; in response to pairing the external electronic device and the connector, establish, via the port and the connector, a communication channel with the external electronic device; and exchange, via the communication channel, data with the external electronic device.
15: The medical device of clause 14, wherein the wired protocol comprises a universal serial bus (USB) protocol, and the RF communication protocol comprises a near field communication (NFC) protocol.
16: The medical device of clause 14 or 15, wherein: the connector comprises a first short-range wireless communication antenna; and the external electronic device comprises a second short-range wireless communication antenna.
17: The medical device of any of clauses 14-16, wherein connecting the connector to the power supply further comprises: receiving a connector identifier; authenticating the connector identifier; and connecting the connector to the power supply in response to the connector identifier being authenticated.
18: The medical device of any of clauses 14-17, wherein the RF communication protocol comprises a short-range wireless communication protocol, and wherein the connector comprises a short-range wireless communication antenna satisfying a power characteristic, a wavelength characteristic, or a frequency characteristic associated with the short-range wireless communication protocol.
19: The medical device of any of clauses 14-18, wherein the RF communication protocol signal includes an identification capability associated with the electric device being positioned at a distance of 4-10 centimeters from the medical device.
20: The medical device of any of clauses 14-19, wherein the medical device comprises an ultrasound functionality, a video laryngoscope functionality, a payment system functionality, a smart phone functionality, an employee badge functionality, or RF asset tracking tag functionality.
21: A system, comprising: a processor; and non-transitory memory storing computer-executable instructions that, when executed by the processor, cause the processor to perform operations comprising: identify a portable wireless device being positioned at a distance from a medical device communicatively coupled to short-range wireless communication adapter device, the distance being less than or equal to a threshold distance associated with a radio frequency (RF) communication protocol; receive, from the portable wireless device, first communications in a communication associated with the RF communication protocol; convert the first communications associated with the RF communication protocol to converted data associated with a wired protocol; identify that a pairing request value in the converted data satisfies a pairing request characteristic; in response to identifying that the pairing request value satisfies the pairing request characteristic, pair the portable wireless device and the short-range wireless communication adapter device; in response to pairing the portable wireless device and the short-range wireless communication adapter device, exchanging, via the short-range wireless communication adapter device, second communications with the portable wireless device.
22: The system of clause 21, wherein: the RF communication protocol comprises a short-range wireless communication protocol; the short-range wireless communication adapter device comprises a first short-range wireless communication antenna; and the portable wireless device comprises a second short-range wireless communication antenna; and a size of the first short-range wireless communication antenna or a size of the second short-range wireless communication antenna satisfies a power characteristic, a wavelength characteristic, and a frequency characteristic associated with the short-range wireless communication protocol.
23: The system of clause 21 or 22, wherein the pairing request value comprises an identifier, an authentication flag, and a type of information.
24: A method, comprising: receiving, via a medical device communicatively connected to a short-range wireless communication adapter device, first communications associated with a short-range wireless communication protocol; in response to receiving the first communications, identifying a wireless device separated by a distance from the short-range wireless communication adapter device, the distance being less than or equal to a threshold distance, converting the first communications to converted communications associated with a wired protocol; identifying, in the converted communications, a pairing request value, the pairing request value comprising an identifier, an authentication flag, or a type of information; identifying a pairing request characteristic being satisfied by the pairing request value; and in response to identifying that the pairing request value is satisfied by the pairing request characteristic, exchanging, with the short-range wireless communication adapter device, second communications with the wireless device.
25: The method of clause 24, wherein the short-range wireless communication adapter device comprises an external short-range wireless communication adapter device being separate from a port of the medical device, further comprising: activating the external short-range wireless communication adapter device in response to the external short-range wireless communication adapter device being inserted into the port.
26: The method of clause 24 or 25, further comprising: activating the short-range wireless communication adapter device in response to the medical device being activated, the short-range wireless communication adapter device being integrated with the medical device.
27: The method of any of clauses 24-26, wherein the first communications comprise near field communication (NFC) communications, and the converted communications comprise universal serial bus (USB) communications, wherein converting the first communications further comprises converting the NFC communications to the USB communications, and wherein identifying the pairing request characteristic further comprises identifying, in the USB communications, the pairing request characteristic.
28: The method of any of clauses 24-27, further comprising: performing, by the medical device and the wireless device, a tap-to-pair pairing process, wherein the tap-to-pair pairing process comprises the identifying of the wireless device, the converting of the first communications, the identifying of the pairing request value, the identifying of the pairing request characteristic, and the exchanging of the second communications.
29: The method of any of clauses 24-28, wherein receiving the converted communications further comprises: receiving, via a port of the medical device, the converted communications comprising the identifier, the authentication flag, and the type of information.
30: The method of any of clauses 24-29, wherein the first communications are received by an antenna for the short-range wireless communication adapter device, and the antenna has a power characteristic, a wavelength characteristic, and a frequency characteristic associated with the short-range wireless communication protocol.
31: The method of any of clauses 24-30, wherein exchanging the second communications further comprises: in response to the pairing request characteristic being satisfied by the pairing request value, setting a pairing request flag; and in response to the pairing request flag and a user selection, exchanging the second communications, the user selection being received via user input to an input device of the medical device, the user selection identifying a notification confirming the wireless device is authenticated.
32: The method of any of clauses 24-31, wherein the wireless device comprises a sensor bundle, the sensor bundle comprising electrodes utilized to capture data representing electrical signals indicative of an electrical activity of a heart of an individual, and wherein exchanging the second communications further comprises: exchanging, via a medical device port and the short-range wireless communication adapter device, the second communications in response to both a first distance characteristic and a second distance characteristic being satisfied, the first distance characteristic being a maximum distance between a first short-range wireless communication transceiver of the short-range wireless communication adapter device and a second short-range wireless communication transceiver of a housing of the sensor bundle, the second distance characteristic comprising a second maximum distance between the second short-range wireless communication transceiver of the housing and a third short-range wireless communication transceiver of the sensor bundle.
33: The method of any of clauses 24-32, further comprising: receiving a selection via user input being identified by an input device of the medical device; and activating the short-range wireless communication adapter device in response to the selection; wherein identifying the wireless device further comprises: identifying the wireless device in response to the selection being received and the short-range wireless communication adapter device being activated.
34: A medical device, comprising: a display; a power supply; and a processor configured to: present, via the display, an activation notification associated with a radio frequency (RF) communication adaptor device; activate the RF communication adaptor device by connecting the RF communication adaptor device to the power supply; identify a portable wireless device being positioned within a threshold distance of the RF communication adaptor device; in response to identifying the portable wireless device being positioned within a threshold distance of the RF communication adaptor device, pair the portable wireless device and the RF communication adaptor device; in response to pairing the portable wireless device and the RF communication adaptor device, exchange, via the RF communication adaptor device, communications with the portable wireless device.
35: The medical device of clause 34, wherein the RF communication adaptor device performs a near field communication (NFC) communications to universal serial bus (USB) communications conversion.
36: The medical device of clause 34 or 35, wherein: the RF communication adaptor device comprises a first near field communication (NFC) antenna; and the portable wireless device comprises a second NFC antenna.
37: The medical device of any of clauses 34-36, wherein activating the portable wireless device further comprises: receiving an RF communication adaptor device identifier; authenticating the RF communication adaptor device identifier; and connecting the RF communication adaptor device to the power supply in response to the RF communication adaptor device identifier being authenticated.
38: The medical device of any of clauses 34-37, wherein the RF communication adaptor device comprises a RF communication antenna satisfying a power characteristic, a wavelength characteristic, and a frequency characteristic associated with an RF communication protocol.
39: The medical device of any of clauses 34-38, wherein the processor is further configured to: perform, via the processor, a tap-to-pair pairing process with the portable wireless device, the tap-to-pair pairing process comprising identifying the portable wireless device and pairing the portable wireless device further comprises.
40: The medical device of any of clauses 34-39, wherein the RF communication adaptor device is separate from a port of the medical device, and wherein activating the RF communication adaptor device further comprises activating the RF communication adaptor device in response to the RF communication adaptor device being inserted into the port.

### CONCLUSION

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A system, comprising:
a connector configured to exchange radio frequency (RF) communication signals using RF communication protocols;
an electronic device; and
a medical device comprising:
a power supply;
a port configured to exchange wired signals using a wired protocol, the port configured to receive the connector; and
a processor configured to:
identify the connector being inserted into the port;
receive first data from the connector, the first data identifying an RF communication protocol;
activate the connector by connecting, via the port, the connector to the power supply;
identify the electronic device being positioned at a distance from the connector, the distance being less than or equal to a threshold distance associated with the RF communication protocol;
receive, from the electronic device, second data in a communication associated with the RF communication protocol;
convert the second data associated with the RF communication protocol to converted data associated with the wired protocol;
identify that a pairing request value in the converted data satisfies a pairing request characteristic, the pairing request value comprising an identifier, an authentication flag, or a type of information;
in response to identifying that the pairing request value satisfies the pairing request characteristic, pair the electronic device and the connector;
in response to pairing the electronic device and the connector, establish, via the port and the connector, a communication channel with the electronic device; and
utilizing the communication channel to exchange third data with the electronic device.

2. The system of claim 1, wherein:
the connector comprises a first short-range wireless communication antenna associated with a first short-range wireless communication protocol; and
the electronic device comprises a second short-range wireless communication antenna associated with a second short-range wireless communication protocol being a same protocol as the first short-range wireless communication protocol.

3. The system of claim 1, wherein the electronic device comprises an electrocardiogram (ECG) sensor, a blood oxygenation sensor, a capnography sensor, an invasive blood pressure (IBP) sensor, a non-invasive blood pressure sensor, a mechanical cardio pulmonary respiratory (CPR) device, a logistical sensor, a location sensor or a CPR feedback device.

4. A method, comprising:
identifying a connector being inserted into a port of a medical device, the connector being compatible with a short-range wireless communication protocol;
in response to a short-range wireless communication protocol signal, identifying an electronic device in a proximity of the medical device;
converting the short-range wireless communication protocol signal to a wired protocol signal;
receiving, from the port, the wired protocol signal comprising a pairing request value, the pairing request value comprising an identifier, an authentication flag, or a type of information;
identifying that the pairing request value satisfies a pairing request characteristic;
in response to identifying that the pairing request value satisfies the pairing request characteristic, establishing, via the port and the connector, a communication channel with the electronic device; and
exchanging, via the communication channel, data with the electronic device.

5. The method of claim 4, wherein activating the connector further comprises activating the connector in response to the connector being inserted into the port.

6. The method of claim 4, wherein activating the connector further comprises activating the connector in response to the medical device being activated.

7. The method of claim 4, further comprising:
operating the medical device in a payment functionality mode, an inventory control mode, an asset management mode, an employee management functionality, a location services mode, or a patient recording keeping mode.

8. The method of claim 4, wherein the short-range wireless communication protocol signal comprises a near field communication (NFC) signal, and the wired protocol signal comprises a universal serial bus (USB) signal.

9. The method of claim 4, wherein receiving the wired protocol signal further comprises receiving, via the port, the wired protocol signal comprising a security key provided by the electronic device, and
wherein establishing the communication channel further comprises establishing the communication channel with the electronic device, in response to verifying the security key is a valid security key.

10. The method of claim 4, wherein the short-range wireless communication protocol signal is received by an antenna for the connector, and the antenna satisfies a power characteristic, a wavelength characteristic, or a frequency characteristic associated with the short-range wireless communication protocol.

11. The method of claim 4, wherein establishing the communication channel further comprises:
presenting, via a display of the medical device, a notification indicating whether the electronic device is authenticated;
receiving a user selection via user input to an input device of the medical device; and
performing an action in response to the user selection, the action comprising establishing the communication channel or exchanging a message with an external device.

12. The method of claim 4, wherein the electronic device comprises a sensor bundle, the sensor bundle comprising electrodes utilized to capture data representing electrical signals indicative of an electrical activity of a heart of an individual, and
wherein identifying the sensor bundle further comprises:
identifying, via a first short-range wireless communication transceiver of the connector, a second short-range wireless communication transceiver associated with a housing comprising the sensor bundle, and
establishing, via the port and the connector, the communication channel with a sensor of the sensor bundle in response to a third short-range wireless communication transceiver of the sensor bundle being identified as being within a distance of the second short-range wireless communication transceiver as the sensor is being pulled out of the housing.

13. The method of claim 4, wherein identifying the electronic device further comprises:
identifying the electronic device in response to an activation selection being received and the connector being activated, the activation selection being received via user input identified by an input device of the medical device, the connector being activated by power received from the port.

14. A system, comprising:
a connector;
an external electronic device; and
a medical device;
a display;
an input device;
a power supply;
a port comprising a port circuit associated with a wired protocol, the port configured to receive the connector comprising a circuit associated with a radio frequency (RF) communication protocol; and
a processor configured to:
present, via the display, an activation notification associated with the connector;
receive an activation selection via user input to the input device;
activate the connector by connecting, via the port, the connector to the power supply;
identify the external electronic device being positioned within a threshold distance of the connector;
receive, from the external electronic device, an identifier in a communication associated with the RF communication protocol;
in response to receiving the identifier, pairing the external electronic device and the medical device via the connector;
in response to pairing the external electronic device and the connector, establish, via the port and the connector, a communication channel with the external electronic device; and
exchange, via the communication channel, data with the external electronic device.

15. The medical device of claim 14, wherein the wired protocol comprises a universal serial bus (USB) protocol, and the RF communication protocol comprises a near field communication (NFC) protocol.

16. The medical device of claim 14, wherein:
the connector comprises a first short-range wireless communication antenna; and
the external electronic device comprises a second short-range wireless communication antenna.

17. The medical device of claim 14, wherein connecting the connector to the power supply further comprises:
receiving a connector identifier;
authenticating the connector identifier; and
connecting the connector to the power supply in response to the connector identifier being authenticated.

18. The medical device of claim 14, wherein the RF communication protocol comprises a short-range wireless communication protocol, and
wherein the connector comprises a short-range wireless communication antenna satisfying a power characteristic, a wavelength characteristic, or a frequency characteristic associated with the short-range wireless communication protocol.

19. The medical device of claim 14, wherein the RF communication protocol signal includes an identification capability associated with the electric device being positioned at a distance of 4-10 centimeters from the medical device.

20. The medical device of claim 14, wherein the medical device comprises an ultrasound functionality, a video laryngoscope functionality, a payment system functionality, a smart phone functionality, an employee badge functionality, or RF asset tracking tag functionality.
